(19) United States
(12) Patent Application Publication
(10) Pub. No.: US 2025/0180713 A1
(43) Pub. Date: Jun. 5, 2025

(54) DISTANCE MEASURING DEVICE

(71) Applicant: SONY SEMICONDUCTOR SOLUTIONS CORPORATION, KANAGAWA (JP)

(72) Inventor: KEIICHI KURODA, KANAGAWA (JP)

(21) Appl. No.: 18/843,344

(22) PCT Filed: Feb. 17, 2023
(86) PCT No.: PCT/JP2023/005752

§ 371 Date: Sep. 3, 2024

(30) Foreign Application Priority Data
Mar. 14, 2022 (JP) 2022-039019

(51) Int. Cl. G01S 7/4865; G01S 7/481; G01S 17/894

(52) U.S. Cl. CPC G01S 7/4865; G01S 7/4816; G01S 7/4817; G01S 17/894

(57) ABSTRACT

To improve distance measurement accuracy and reduce power consumption of a distance measuring device that performs distance measurement by a ToF method. A distance measuring device according to the present technology includes: a light emitting unit configured to emit light; a sensor unit configured to perform a light receiving operation for distance measurement by a ToF method, for reflected light obtained when an object reflects light emitted from the light emitting unit; a calculation unit configured to calculate a distance by the ToF method on the basis of a light reception signal of the sensor unit; an object detection unit configured to perform object detection processing on the basis of a sensing image obtained by sensing on a distance measurable range that is a view angle range in which distance measurement can be performed using the sensor unit; and a control unit configured to control the calculation unit to calculate a distance to a target object on the basis of a light reception signal obtained by the sensor unit when a position according to a position of the target object detected by the object detection unit is irradiated with light emitted by the light emitting unit.

### TECHNICAL FIELD

The present technology relates to a distance measuring device that performs distance measurement by a time of flight (ToF) method, and relates to a technology for improving distance measurement accuracy, reducing power consumption in distance measurement, and increasing a processing speed.

### BACKGROUND ART

For example, as described in Patent Document 1 below and the like, a distance measuring device that performs distance measurement by a time of flight (ToF) method is known.

The distance measuring device by the ToF method is provided with a light emitting unit configured to emit active light to a distance measurement target object. In the ToF method, reflected light of the active light with which the target object is irradiated is received, and a distance is calculated on the basis of a time difference between a light emission start timing of the active light and a light reception timing of the reflected light. In particular, in an indirect ToF method, a distance to an object is calculated on the basis of a phase difference between a light emission start timing of the active light and a light reception timing of the reflected light.

### CITATION LIST

### Patent Document

Patent Document 1: Japanese Patent Application Laid-Open No. 2020-153865

### SUMMARY OF THE INVENTION

### Problems to be Solved by the Invention

Here, as a technique of irradiating the entire distance measurement target range with active light, for example, a technique of diffusing light from a single light source with a lens or the like and performing irradiation with the light can be considered. However, in a case of this technique, since the light is diffused, the target object cannot be irradiated with sufficient light, it is difficult to obtain a sufficient amount of reflected light, and it is difficult to improve distance measurement accuracy. In particular, it is difficult for the active light to reach a distant object, and it is difficult to perform distance measurement of the distant object.

Whereas, it is also conceivable to adopt a configuration in which the entire distance measurement target range is irradiated using a plurality of light sources. In this case, although an amount of reflected light from the target object can be easily increased, there is a problem that power consumption required for emitting the active light is increased.

The present technology has been made in view of the problems described above, and an object of the present technology is to improve distance measurement accuracy, reduce power consumption, and increase a processing speed of a distance measuring device that performs distance measurement by the ToF method.

### Solutions to Problems

A first distance measuring device according to the present technology includes: a light emitting unit configured to emit light; a sensor unit configured to perform a light receiving operation for distance measurement by a ToF method, for reflected light obtained when an object reflects light emitted from the light emitting unit; a calculation unit configured to calculate a distance by the ToF method on the basis of a light reception signal of the sensor unit; an object detection unit configured to perform object detection processing on the basis of a sensing image obtained by sensing on a distance measurable range that is a view angle range in which distance measurement can be performed using the sensor unit; and a control unit configured to control the calculation unit to calculate a distance to a target object on the basis of a light reception signal obtained by the sensor unit when a position according to a position of the target object detected by the object detection unit is irradiated with light emitted by the light emitting unit.

According to the configuration described above, it is possible to calculate a distance to the target object by irradiating, with the active light, not the entire distance measurable range but only a part according to a position where the target object is present.

Furthermore, a second distance measuring device according to the present technology includes: a sensor unit configured to perform a light receiving operation for distance measurement by a ToF method, for reflected light obtained when an object reflects light emitted from a light emitting unit that emits light; a calculation unit configured to calculate a distance by the ToF method on the basis of a light reception signal of the sensor unit; an object detection unit configured to perform object detection processing on the basis of a sensing image obtained by sensing on a distance measurable range that is a view angle range in which distance measurement can be performed using the sensor unit; and a control unit configured to control the calculation unit to calculate a distance to a target object on the basis of a light reception signal obtained by the sensor unit when a position according to a position of the target object detected by the object detection unit is irradiated with light emitted by the light emitting unit.

Such a second distance measuring device can also obtain an action similar to that of the first distance measuring device described above.

### BRIEF DESCRIPTION OF DRAWINGS

FIG. 1 is a block diagram for explaining a configuration example of a distance measuring device as a first embodiment according to the present technology.

FIG. 2 is a block diagram illustrating an internal circuit configuration example of a sensor unit in the first embodiment.

FIG. 3 is an equivalent circuit diagram of a pixel included in the sensor unit in the first embodiment.

FIG. 4 is a diagram for explaining a distance measurement technique as the first embodiment.

FIG. 5 is an explanatory diagram of another example of irradiation light at a time of distance measurement.

FIG. 6 is a flowchart illustrating a specific processing procedure example for implementing a distance measurement technique as the first embodiment.

FIG. 7 is an explanatory diagram of another example of position adjustment of irradiation light.

FIG. 8 is a block diagram for explaining a configuration example of a distance measuring device as a first example of a second embodiment.

FIG. 9 is a block diagram illustrating an internal circuit configuration example of a sensor unit included in the distance measuring device as the first example of the second embodiment.

FIG. 10 is a flowchart illustrating a specific processing procedure example for implementing a distance measurement technique as the first example in the second embodiment.

FIG. 11 is a diagram for explaining an example of an object detection pixel region.

FIG. 12 is a block diagram illustrating an internal circuit configuration example of a sensor unit included in a distance measuring device as a second example of the second embodiment.

FIG. 13 is a block diagram illustrating an internal circuit configuration example of the sensor unit included in the distance measuring device as the second example of the second embodiment.

FIG. 14 is an explanatory diagram of a baseline distance.

FIG. 15 is a block diagram for explaining a configuration example of a distance measuring device as a third embodiment.

FIG. 16 is an explanatory diagram of the distance measurement technique as the third embodiment.

FIG. 17 is a flowchart illustrating a specific processing procedure example for implementing a distance measurement technique as the third embodiment.

FIG. 18 is an explanatory diagram of a modification in which a light emitting unit includes a plurality of light sources.

FIG. 19 is a block diagram for explaining a configuration example of a distance measuring device as a modification.

### MODE FOR CARRYING OUT THE INVENTION

Hereinafter, embodiments according to the present technology will be described in the following order with reference to the accompanying drawings.
<1. First embodiment>
(1-1. Overall configuration of distance measuring device)
(1-2. Configuration of sensor unit)
(1-3. Distance measurement technique as first embodiment)
(1-4. Processing procedure)
<2. Second embodiment>
(2-1. First example)
(2-2. Second example)
<3. Third embodiment>
<4. Modification>
<5. Summary of embodiment>
<6. Present Technology>

### 1. First Embodiment

### 1-1. Overall Configuration of Distance Measuring Device

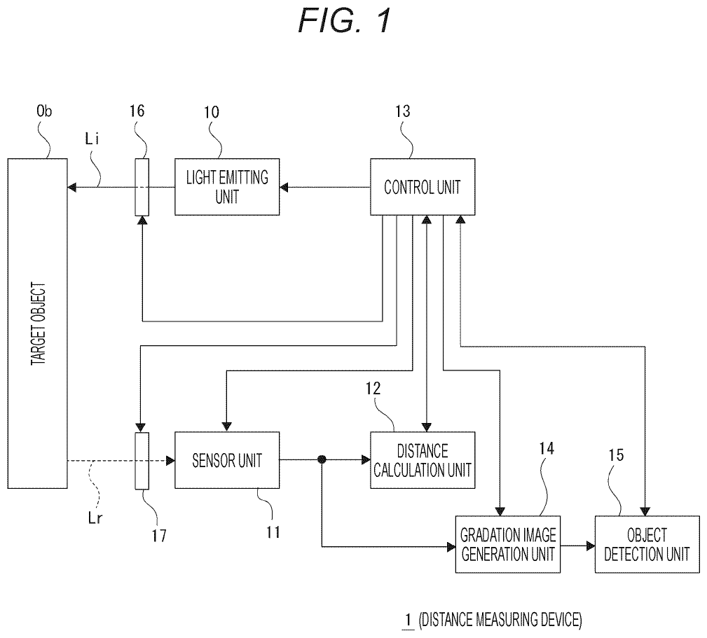

FIG. 1 is a block diagram for explaining a configuration example of a distance measuring device 1 which is a distance measuring device as a first embodiment according to the present technology.

As illustrated in the figure, the distance measuring device 1 includes: a light emitting unit 10 configured to emit light; and a sensor unit 11 configured to be able to perform a light receiving operation corresponding to a time of flight (ToF) method for reflected light Lr (illustrated as reflected light Lr from a target object Ob in the figure) obtained when an object reflects light (illustrated as irradiation light Li in the figure) emitted from the light emitting unit 10. The distance measuring device 1 also includes a distance calculation unit 12, a control unit 13, a gradation image generation unit 14, an object detection unit 15, a beam steering unit 16, and a filter effect control unit 17.

The distance measuring device 1 can perform distance measurement by the ToF method on a pixel basis. Specifically, the distance measuring device 1 in this example is configured to be able to perform distance measurement by an indirect ToF method. The indirect ToF method is defined as a distance measuring method of calculating a distance to the target object Ob on the basis of a phase difference between the irradiation light Li with respect to the target object Ob and the reflected light Lr obtained when the irradiation light Li is reflected by the target object Ob.

The light emitting unit 10 includes one or a plurality of light emitting elements as a light source, and emits the irradiation light Li. In this example, the light emitting unit 10 includes a single vertical cavity surface emitting laser (VCSEL) as a light emitting element, and emits infrared (IR) light having, for example, a wavelength in a range of 750 nm to 1400 nm, as the irradiation light Li.

The sensor unit 11 receives the reflected light Lr. Specifically, the light receiving operation of the reflected light Lr is performed to allow the phase difference between the reflected light Lr and the irradiation light Li to be detected.

As will be described later, the sensor unit 11 of this example includes a pixel array unit 111 having a plurality of pixels Px two-dimensionally arranged in which each of the pixels Px includes a photoelectric conversion element (photodiode PD) and a first transfer gate element (transfer transistor TG-A) and a second transfer gate element (transfer transistor TG-B) for transfer of accumulated charges of the photoelectric conversion element, and the sensor unit 11 performs a light receiving operation for distance measurement by the indirect ToF method for every pixel Px.

Note that the light receiving operation of the sensor unit 11 will be described later again.

The control unit 13 is configured as, for example, a microcomputer or the like including a CPU, a ROM, a RAM, and the like, and controls a light emitting operation of the irradiation light Li by the light emitting unit 10, an operation of the sensor unit 11, and operations of the gradation image generation unit 14, the object detection unit 15, the beam steering unit 16, and the filter effect control unit 17 described later.

In a case of performing distance measurement by the indirect ToF method, light subjected to intensity modulation to change intensity at a predetermined cycle is used as the irradiation light Li. Specifically, in this example, pulsed light is repeatedly emitted at a predetermined cycle as the irradiation light Li. Hereinafter, such a light emission cycle of the pulsed light is referred to as a “light emission cycle Cl”. Furthermore, a period between light emission start timings of the pulsed light when the pulsed light is repeatedly emitted at the light emission cycle Cl is referred to as “one modulation period Pm” or simply a “modulation period Pm”.

The control unit 13 controls the light emission operation of the light emitting unit 10 so as to emit the irradiation light Li only during a predetermined light emitting period in every modulation period Pm.

In the indirect ToF method, the light emission cycle Cl is relatively fast at about, for example, several tens of MHz to several hundreds of MHz.

Here, as is known, in the indirect ToF method, signal charges accumulated in the photoelectric conversion element in the pixel Px of the sensor unit 11 are distributed to two floating diffusions (FD) by the first transfer gate element and the second transfer gate element which are alternately turned ON. At this time, a cycle in which the first transfer gate element and the second transfer gate element are alternately turned ON is the same cycle as the light emission cycle Cl of the light emitting unit 10. That is, each of the first transfer gate element and the second transfer gate element is turned ON once in every modulation period Pm, and the distribution of the signal charges into the two floating diffusions as described above is repeatedly performed in every modulation period Pm.

For example, the transfer transistor TG-A as the first transfer gate element is turned ON in the light emitting period of the irradiation light Li in the modulation period Pm, and the transfer transistor TG-B as the second transfer gate element is turned ON in the non-light emitting period of the irradiation light Li in the modulation period Pm.

Furthermore, in a case where IQ modulation (I: in-phase (in-phase component), Q: quadrature (quadrature component)) is applied in distance measurement calculation, the transfer transistor TG-A may be turned ON/OFF in a cycle in which a phase is shifted by 90 degrees from a light emission cycle of the irradiation light Li, and the transfer transistor TG-B may be turned ON/OFF in a cycle in which a phase is shifted by 270 degrees from a light emission cycle of the irradiation light Li.

As described above, since the light emission cycle Cl is relatively fast, the signal charges accumulated in each floating diffusion by one distribution using the first and second transfer gate elements as described above is relatively small. Therefore, in the indirect ToF method, light emission of the irradiation light Li is repeated about several thousand times to several tens of thousands times per distance measurement. While the irradiation light Li is repeatedly emitted in this manner, the sensor unit 11 repeatedly distributes signal charges to each floating diffusion by using the first and second transfer gate elements as described above.

As understood from the description above, in the sensor unit 11, the first transfer gate element and the second transfer gate element are driven at a timing based on the light emission cycle of the irradiation light Li in every pixel Px. Therefore, the control unit 13 controls the light receiving operation performed by the sensor unit 11 and the light emitting operation performed by the light emitting unit 10 on the basis of a common clock.

The distance calculation unit 12 calculates a distance to the target object Ob on the basis of the charge signals accumulated in each floating diffusion by the above-described distribution operation in the sensor unit 11.

By performing predetermined calculation by the indirect ToF method on the charge signals accumulated in each floating diffusion, it is possible to calculate, for every pixel Px, a distance to an object whose reflected light Lr is received by the pixel Px.

Note that a known technique can be used as a technique of calculating distance information by the indirect ToF method on the basis of two types of detection signals (detection signals of every floating diffusion) for every pixel Px, and the description thereof will be omitted here.

The gradation image generation unit 14 generates a gradation image based on a charge signal of each floating diffusion obtained for every pixel Px by the sensor unit 11 on the basis of an instruction from the control unit 13.

The gradation image mentioned here means an image indicating magnitude of a light reception amount for every pixel.

The light reception amount (a light reception amount in a light receiving period Pr to be described later) in each pixel Px can be estimated with a light reception signal obtained by the sensor unit 11 corresponding to the indirect ToF method, that is, charge signals accumulated in each floating diffusion for every pixel Px described above. Specifically, by adding the charge signals of individual floating diffusions for every pixel Px, a signal indicating a light reception amount in the pixel Px is obtained.

The gradation image generation unit 14 receives, for every pixel Px, the charge signals accumulated in each floating diffusion after the sensor unit 11 performs the charge distribution over the predetermined period as described above, and adds the charge signals of the individual floating diffusions to generate a gradation image indicating magnitude of a light reception amount for every pixel Px.

Note that, in this example, the number of effective pixels of the sensor unit 11 is 640 horizontal pixels×480 vertical pixels. Therefore, the maximum resolution of the gradation image generated by the gradation image generation unit 14 is set to a VGA resolution.

The object detection unit 15 performs object detection processing based on the gradation image generated by the gradation image generation unit 14 on the basis of an instruction from the control unit 13.

In the object detection processing here, processing of detecting an object of a predetermined type such as, for example, a person, an animal, a car, or an airplane as the target object Ob is performed. For example, it is conceivable to configure the object detection unit 15 as an image recognition device based on artificial intelligence (AI) subjected to machine learning to detect an object of a target type.

Alternatively, the object detection unit 15 may be configured to detect an object of a target type by rule-based processing such as, for example, template matching processing using a template image.

The object detection unit 15 also performs processing of specifying a position of a detected target object Ob and an object detection region which is a region where the target object Ob is present.

The beam steering unit 16 performs beam steering on light (IR light in this example) emitted from the light emitting unit 10, in other words, changes a direction of an optical axis of the irradiation light Li. Examples of a specific configuration of the beam steering unit 16 include, for example, a galvano mirror and a liquid crystal panel (polarizing element) inserted into an optical path of the irradiation light Li, an optical phase array (OPA), and an actuator (for example, a motor or the like) for pan-tilting an optical system of the irradiation light Li including the light emitting unit 10.

The beam steering unit 16 changes a direction of an optical axis of the irradiation light Li in accordance with an instruction of the control unit 13.

The filter effect control unit 17 is an optical element configured to be switchable between a filter enabling mode in which an optical bandpass filter effect of setting a wavelength band of light emitted from the light emitting unit 10 (in this example, a wavelength band of IR light) as a target wavelength band is applied to light received by the sensor unit 11; and a filter disabling mode in which the optical bandpass filter effect is not applied to the light received by the sensor unit 11.

Examples of a specific configuration of the filter effect control unit 17 include, for example, a liquid crystal panel configured to be able to switch ON/OFF of the above-described optical bandpass filter effect. Alternatively, a configuration is also conceivable in which the filter effect control unit 17 enables switching between the filter enabling mode and the filter disabling mode described above by inserting or removing an IR filter into or from a light receiving optical path of the sensor unit 11.

The filter effect control unit 17 switches between the filter enabling mode and the filter disabling mode on the basis of an instruction from the control unit 13.

### 1-2. Configuration of Sensor Unit

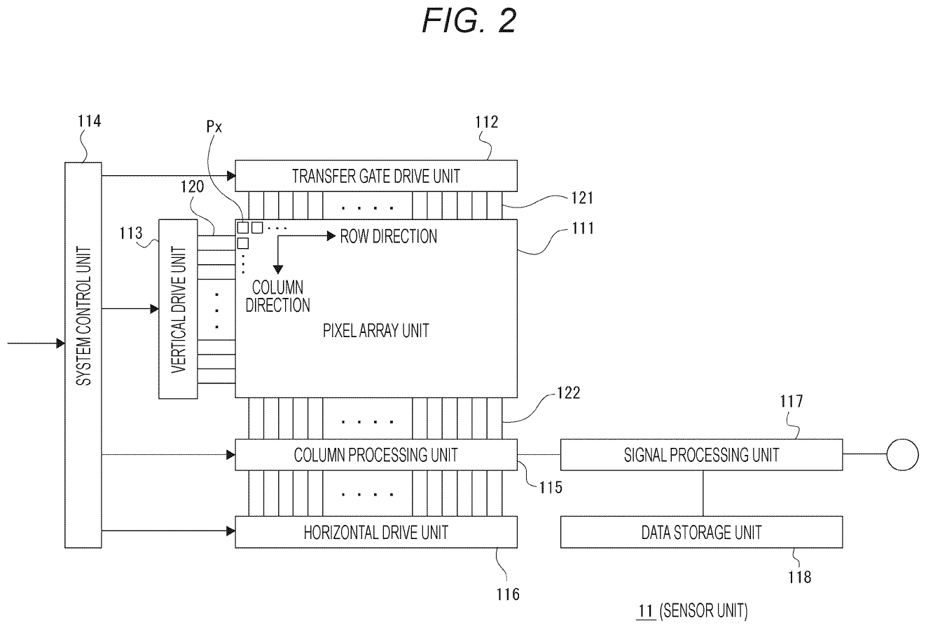

FIG. 2 is a block diagram illustrating an internal circuit configuration example of the sensor unit 11.

As illustrated, the sensor unit 11 includes the pixel array unit 111, a transfer gate drive unit 112, a vertical drive unit 113, a system control unit 114, a column processing unit 115, a horizontal drive unit 116, a signal processing unit 117, and a data storage unit 118.

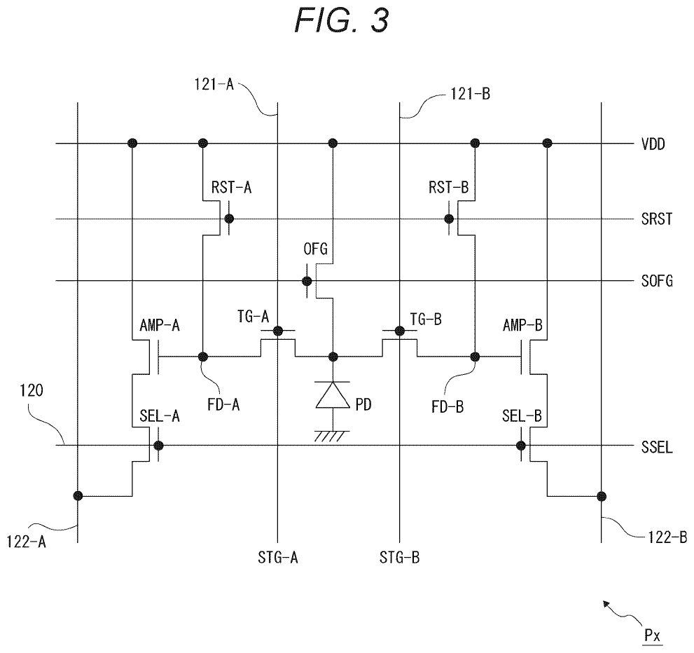

The pixel array unit 111 has a configuration in which a plurality of pixels Px is two-dimensionally arranged in a matrix in a row direction and a column direction. Each pixel Px includes the photodiode PD as described later as a photoelectric conversion element. Note that details of the pixel Px will be described again with reference to FIG. 3.

Here, the row direction refers to an arrangement direction of the pixels Px in a lateral direction, and the column direction refers to an arrangement direction of the pixels Px in a perpendicular direction. In the drawing, the row direction is a horizontal direction, and the column direction is a vertical direction.

In the pixel array unit 111, with respect to a matrix-like pixel array, a row drive line 120 is wired along the row direction for every pixel row, and two gate drive lines 121 and two vertical signal lines 122 are each wired along the column direction for each pixel column. For example, the row drive line 120 transmits a drive signal for driving when reading a signal from the pixel Px. Note that, although the row drive line 120 is illustrated as one wiring in FIG. 2, the wiring is not limited to one. One end of the row drive line 120 is connected to an output end corresponding to each row of the vertical drive unit 113.

The system control unit 114 includes, for example, a timing generator that generates various timing signals, and performs drive control of the transfer gate drive unit 112, the vertical drive unit 113, the column processing unit 115, the horizontal drive unit 116, and the like on the basis of various timing signals generated by the timing generator or the like.

The transfer gate drive unit 112 drives two transfer gate elements provided in every pixel Px through the two gate drive lines 121 provided in each pixel column as described above on the basis of control of the system control unit 114.

As described above, the two transfer gate elements are alternately turned ON in every modulation period Pm. Therefore, the system control unit 114 supplies a clock input from the control unit 13 described above to the transfer gate drive unit 112, and the transfer gate drive unit 112 drives two transfer gate elements on the basis of the clock.

The vertical drive unit 113 includes a shift register, an address decoder, and the like, and drives the pixels Px of the pixel array unit 111 at the same time for all the pixels, in units of rows or the like. That is, the vertical drive unit 113 constitutes a drive unit that controls operation of each pixel Px of the pixel array unit 111 together with the system control unit 114 that controls the vertical drive unit 113.

A light reception signal output (read) from each pixel Px of a pixel row in accordance with drive control by the vertical drive unit 113, specifically, a signal (charge signal) according to the signal charges accumulated in each of the two floating diffusions provided in every pixel Px, is input to the column processing unit 115 through the corresponding vertical signal line 122. The column processing unit 115 performs predetermined signal processing on the light reception signal read from each pixel Px via the vertical signal line 122, and temporarily holds the light reception signal after the signal processing. Specifically, the column processing unit 115 performs noise removal processing by correlated double sampling (CDS), analog to digital (A/D) conversion processing, and the like as signal processing.

Here, reading of two light reception signals (detection signals of every floating diffusion) from each pixel Px is performed once for every predetermined number of times of repeated light emission of the irradiation light Li (every several thousand times to several tens of thousands of times of repeated light emission described above).

Therefore, the system control unit 114 controls the vertical drive unit 113 on the basis of the clock described above such that a reading timing of the light reception signal from each pixel Px becomes a timing for every predetermined number of times of repeated light emission of the irradiation light Li.

The horizontal drive unit 116 includes a shift register, an address decoder, and the like, and sequentially selects a unit circuit corresponding to the pixel column in the column processing unit 115. When the selective scanning is performed by the horizontal drive unit 116, the light reception signal subjected to the signal processing for every unit circuit in the column processing unit 115 is sequentially output.

The signal processing unit 117 has at least an arithmetic processing function, and performs predetermined signal processing on the light reception signal output from the column processing unit 115.

The data storage unit 118 temporarily stores data necessary for signal processing in the signal processing unit 117.

FIG. 3 illustrates an equivalent circuit of the pixels Px two-dimensionally arranged in the pixel array unit 111.

A pixel Px includes one photodiode PD and one overflow (OF) gate transistor OFG as photoelectric conversion elements. Furthermore, the pixel Px includes two each of transfer transistors TG as the transfer gate elements, floating diffusions FD, reset transistors RST, amplification transistors AMP, and selection transistors SEL.

Here, in a case where the transfer transistors TG, the floating diffusions FD, the reset transistors RST, the amplification transistors AMP, and the selection transistors SEL provided two each in the pixel Px are distinguished from each other, as illustrated in FIG. 3, they are denoted as transfer transistors TG-A and TG-B, floating diffusions FD-A and FD-B, reset transistors RST-A and RST-B, amplification transistors AMP-A and AMP-B, and selection transistors SEL-A and SEL-B.

An OF gate transistor OFG, the transfer transistors TG, the reset transistors RST, the amplification transistors AMP, and the selection transistors SEL include, for example, N-type MOS transistors.

The OF gate transistor OFG becomes conductive when an OF gate signal SOFG supplied to the gate is turned ON. When the OF gate transistor OFG enters the conductive state, the photodiode PD is clamped at a predetermined reference potential VDD, and the accumulated charges are reset.

Note that the OF gate signal SOFG is supplied from the vertical drive unit 113, for example.

The transfer transistor TG-A becomes conductive when a transfer drive signal STG-A supplied to the gate is turned ON, and transfers the signal charges accumulated in the photodiode PD to the floating diffusion FD-A. The transfer transistor TG-B becomes conductive when a transfer drive signal STG-B supplied to the gate is turned ON, and transfers the charges accumulated in the photodiode PD to the floating diffusion FD-B.

The transfer drive signals STG-A and STG-B are supplied from the transfer gate drive unit 112 through gate drive lines 121-A and 121-B, each of which is provided as one of the gate drive lines 121 illustrated in FIG. 2.

The floating diffusions FD-A and FD-B are charge holding units that temporarily hold the charges transferred from the photodiode PD.

The reset transistor RST-A becomes conductive when a reset signal SRST supplied to the gate is turned ON, and resets the potential of the floating diffusion FD-A to the reference potential VDD. Similarly, the reset transistor RST-B becomes conductive when the reset signal SRST supplied to the gate is turned ON, and resets the potential of the floating diffusion FD-B to the reference potential VDD.

Note that the reset signal SRST is supplied from the vertical drive unit 113, for example.

The amplification transistor AMP-A has a source connected to a vertical signal line 122-A via the selection transistor SEL-A, and a drain connected to the reference potential VDD (constant current source) to constitute a source follower circuit. The amplification transistor AMP-B has a source connected to a vertical signal line 122-B via the selection transistor SEL-B and a drain connected to the reference potential VDD (constant current source) to constitute a source follower circuit.

Here, each of the vertical signal lines 122-A and 122-B is provided as one of the vertical signal lines 122 illustrated in FIG. 2.

The selection transistor SEL-A is connected between the source of the amplification transistor AMP-A and the vertical signal line 122-A, becomes conductive when a selection signal SSEL supplied to the gate is turned ON, and outputs the charges held in the floating diffusion FD-A to the vertical signal line 122-A via the amplification transistor AMP-A.

The selection transistor SEL-B is connected between the source of the amplification transistor AMP-B and the vertical signal line 122-B, becomes conductive when the selection signal SSEL supplied to the gate is turned ON, and outputs the charges held in the floating diffusion FD-B to the vertical signal line 122-B via the amplification transistor AMP-A.

Note that the selection signal SSEL is supplied from the vertical drive unit 113 via the row drive line 120.

The operation of the pixel Px will be briefly described.

First, before light reception is started, a reset operation for resetting the charges in the pixel Px is performed in all the pixels. That is, for example, the OF gate transistor OFG, each reset transistor RST, and each transfer transistor TG are turned ON (conductive state), and the accumulated charges of the photodiode PD and each floating diffusion FD are reset.

After resetting the accumulated charges, a light receiving operation for distance measurement is started in all the pixels. The light receiving operation mentioned here means a light receiving operation performed for one time of distance measurement. That is, during the light receiving operation, an operation of alternately turning on the transfer transistors TG-A and TG-B is repeated a predetermined number of times (in this example, about several thousand times to several tens of thousands of times). Hereinafter, a period of the light receiving operation performed for such one distance measurement is referred to as a “light receiving period Pr”.

In the light receiving period Pr, in one modulation period Pm of the light emitting unit 10, for example, after a period in which the transfer transistor TG-A is turned ON (that is, a period in which the transfer transistor TG-B is turned OFF) is continued over a light emitting period of the irradiation light Li, a remaining period, that is, a non-light emitting period of the irradiation light Li is a period in which the transfer transistor TG-B is turned ON (that is, a period in which the transfer transistor TG-A is turned OFF). That is, in the light receiving period Pr, an operation of distributing the charges of the photodiode PD to the floating diffusions FD-A and FD-B is repeated a predetermined number of times within one modulation period Pm.

Then, when the light receiving period Pr ends, each pixel Px of the pixel array unit 111 is selected sequentially. In the selected pixel Px, the selection transistors SEL-A and SEL-B are turned ON. Thus, the charges accumulated in the floating diffusion FD-A are output to the column processing unit 115 via the vertical signal line 122-A. Furthermore, the charges accumulated in the floating diffusion FD-B are output to the column processing unit 115 via the vertical signal line 122-B.

As described above, one light receiving operation ends, and the next light receiving operation starting from the reset operation is executed.

Here, the reflected light Lr received by the pixel Px is delayed according to the distance to the target object Ob from the timing at which the light emitting unit 10 emits the irradiation light Li. A distribution ratio of the charges accumulated in the two floating diffusions FD-A and FD-B changes depending on a delay time according to the distance to the target object Ob, and thus the distance to the target object Ob can be obtained from the distribution ratio of the charges accumulated in the two floating diffusions FD-A and FD-B.

Here, in the description above, a case has been exemplified in which distance measurement by a so-called two-phase method is performed for distance measurement by the indirect ToF method. That is, a case has been exemplified in which a distance is calculated from two kinds of light reception signals (charge signals individually accumulated in the floating diffusions FD-A and FD-B) obtained by performing charge distribution with the transfer drive signal STG in which the phase difference with respect to the light emission signal is set to 0 degrees and 180 degrees.

However, as the distance measurement by the indirect ToF method, distance measurement by a so-called four-phase method can also be performed. This four-phase method is to perform distance measurement calculation based on the IQ modulation described above, and uses not only light reception signals having phase differences of 0 degrees and 180 degrees with respect to light emission signals, but also light reception signals having phase differences of 90 degrees and 270 degrees.

In this case, in the light receiving period Pr, as exemplified above, an operation of performing charge distribution to the floating diffusions FD-A and FD-B to obtain light reception signals having a phase difference of 0 degrees and a phase difference of 180 degrees is performed by using the transfer drive signal STG-A having a phase difference of 0 degrees with respect to the light emission signal and the transfer drive signal STG-B having a phase difference of 180 degrees with respect to the light emission signal, and an operation of performing charge distribution to the floating diffusions FD-A and FD-B to obtain light reception signals having a phase difference of 90 degrees and a phase difference of 270 degrees is performed by using the transfer drive signal STG-A having a phase difference of 90 degrees with respect to the light emission signal and the transfer drive signal STG-B having a phase difference of 270 degrees with respect to the light emission signal.

Note that the distance measurement calculation by the four-phase method performed using the four types of light reception signals having the phase differences of 0 degrees, 180 degrees, 90 degrees, and 270 degrees is known, and detailed description thereof is omitted here.

### 1-3. Distance Measurement Technique as First Embodiment

Here, in this example, it is assumed that a technique of providing a single light source as the light emitting unit 10, diffusing light from the single light source with a lens or the like, and performing irradiation with the light is adopted.

However, in a case of this technique, since the light is diffused, the target object Ob cannot be irradiated with sufficient light, it is difficult to obtain a sufficient amount of reflected light, and it is difficult to improve distance measurement accuracy. In particular, it is difficult for the active light to reach a distant object, and it is difficult to perform distance measurement of the distant object.

Therefore, in the present embodiment, a technique is adopted in which the distance calculation unit 12 performs control to calculate a distance to the target object Ob on the basis of a light reception signal obtained by the sensor unit 11 at a time of irradiation with the irradiation light Li at a position according to a position of the target object Ob detected by the object detection unit 15.

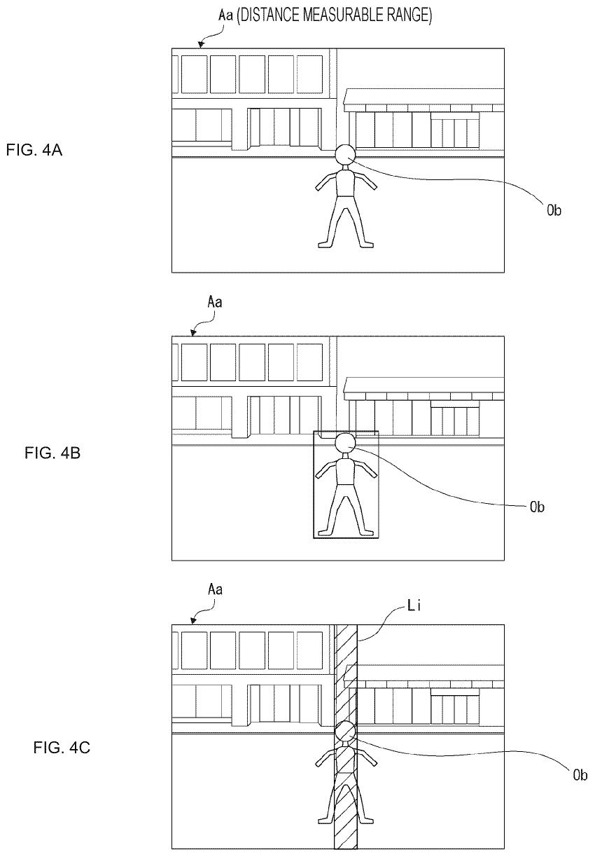

With reference to FIG. 4, a distance measurement technique as the first embodiment will be specifically described.

FIG. 4A illustrates a state in which the target object Ob for distance measurement is present within a distance measurable range Aa for the distance measuring device 1. The distance measurable range Aa means a view angle range in which distance measurement can be performed using the sensor unit 11.

In the present embodiment, when the distance measurement of the target object Ob is performed, first, object detection processing using the target object Ob as an object to be a target is performed using the object detection unit 15. This object detection processing is performed on the basis of a sensing image obtained by sensing on the distance measurable range Aa. Specifically, in this example, the object detection processing is performed on the basis of a gradation image generated on the basis of a light reception signal of the sensor unit 11. More specifically, the object detection processing in this case is performed on a gradation image obtained by causing the sensor unit 11 to execute a light receiving operation in a state where the light emitting unit 10 does not emit light.

As described above, the gradation image is generated by the gradation image generation unit 14 on the basis of a charge signal for each of the floating diffusions FD-A and FD-B obtained by the sensor unit 11 performing the light receiving operation for distance measurement in the light receiving period Pr. Specifically, the gradation image is generated by adding the charge signals of the individual floating diffusions FD for every pixel Px.

Here, in this example, in obtaining the gradation image for object detection, the light emitting unit 10 is brought into a non-light emitting state, that is, the gradation image is obtained on the basis of the reflected light Lr of only ambient light instead of active light. However, at this time, similarly to the case of using the active light, if the optical bandpass filter effect targeting a wavelength band of light emitted by the light emitting unit 10 is enabled, a light reception amount in the sensor unit 11 may decrease, leading to deterioration of object detection accuracy.

Therefore, in the present embodiment, when obtaining the gradation image for the object detection processing, the control unit 13 controls the filter effect control unit 17 to the filter disabling mode.

As a result, light in a wavelength band other than the active light in the ambient light can also be received to generate the gradation image, and object detection accuracy can be improved.

As described above, in the present embodiment, the gradation image for object detection is obtained on the basis of a light reception signal of the sensor unit 11, but this can be rephrased as that the distance measuring sensor and the object detecting sensor are unified.

As a result, it is possible to eliminate the need to separately provide a sensor for object detection, and it is possible to reduce the number of parts, reduce a size and a weight of the distance measuring device, and reduce the cost.

Furthermore, since a sensor used for distance measurement and a sensor used for object detection processing are unified, it is not necessary to perform image alignment as in a case where a separate sensor for object detection is used, and it is possible to prevent distance measurement accuracy from deteriorating depending on accuracy of alignment processing, and to improve distance measurement accuracy.

FIG. 4B schematically illustrates a state in which the target object Ob is detected by the object detection processing performed by the object detection unit 15.

In the present embodiment, in a case where the target object Ob is detected in the distance measurable range Aa as described above, as illustrated in FIG. 4C, a position according to a position of the detected target object Ob is irradiated with the irradiation light Li, and the distance calculation unit 12 calculates a distance to the target object Ob on the basis of a light reception signal obtained by the sensor unit 11 when the position according to the position of the target object Ob is irradiated with the irradiation light Li in this manner.

Specifically, in the first embodiment, as illustrated in FIG. 4C, only a partial region including a position of the detected target object Ob is irradiated with the irradiation light Li, rather than the entire distance measurable range Aa. At this time, the control unit 13 instructs the beam steering unit 16 to control an irradiation position of the irradiation light Li. In this example, the irradiation light Li emitted from the light emitting unit 10 is vertically long light passing through a vertical direction of the distance measurable range Aa as illustrated in FIG. 4C, in other words, continuously covering from an upper end to a lower end of the distance measurable range Aa. In this case, it suffices that a lateral width of the irradiation light Li is shorter than at least a lateral width of the distance measurable range Aa.

In this case, the control unit 13 causes the sensor unit 11 to execute light receiving operation for distance measurement in a state where a region including the detected position of the target object Ob in a horizontal direction in the distance measurable range Aa is irradiated with the vertically long irradiation light Li as illustrated in FIG. 4C. Then, the distance calculation unit 12 performs control to calculate the distance to the target object Ob on the basis of a light reception signal obtained by the light receiving operation.

Here, it is conceivable that the calculation of the distance to the target object Ob by the distance calculation unit 12 is performed on the basis of a light reception signal in an object detection pixel region Ag as follows, for example. Here, the object detection pixel region Ag refers to a pixel region of the sensor unit 11 in which the target object Ob has been detected.

First, on the basis of the charge signal for every floating diffusion FD obtained in each pixel Px of the sensor unit 11, for example, a pixel Px having a light reception amount of a predetermined threshold value or more in the object detection pixel region Ag is detected as a pixel Px that has received the reflected light Lr from the target object Ob. Note that the light reception amount for every pixel Px can be estimated by adding the charge signals for every floating diffusion FD as described above.

Then, an average value of distances calculated for the pixel Px that has received the reflected light Lr as described above is set as the distance to the target object Ob.

Note that a technique of calculating the distance to the target object Ob is not limited to the technique described above. For example, it is conceivable to detect a pixel Px having the largest light reception amount in the object detection pixel region Ag, and set a distance calculated for the pixel Px as the distance to the target object Ob. At this time, in a case where there is a plurality of pixels Px having the maximum light reception amount, it is conceivable to use an average value of distances calculated for those pixels Px.

The distance to the target object Ob in this case is only required to be based on the distance for the pixel Px in the object detection pixel region Ag. That is, any value may be used as long as the value is based on a distance calculated in the object detection pixel region Ag, such as the distance itself of the pixel Px at a predetermined position in the object detection pixel region Ag or an average value of distances for the individual pixels Px in a predetermined pixel region in the object detection pixel region Ag.

Here, when causing the sensor unit 11 to execute the light receiving operation in order to calculate the distance to the target object Ob by irradiation with the irradiation light Li, the control unit 13 controls the filter effect control unit 17 to the filter enabling mode. Specifically, the filter effect control unit 17 performs control to maintain the filter enabling mode at least during an execution period of the light receiving operation.

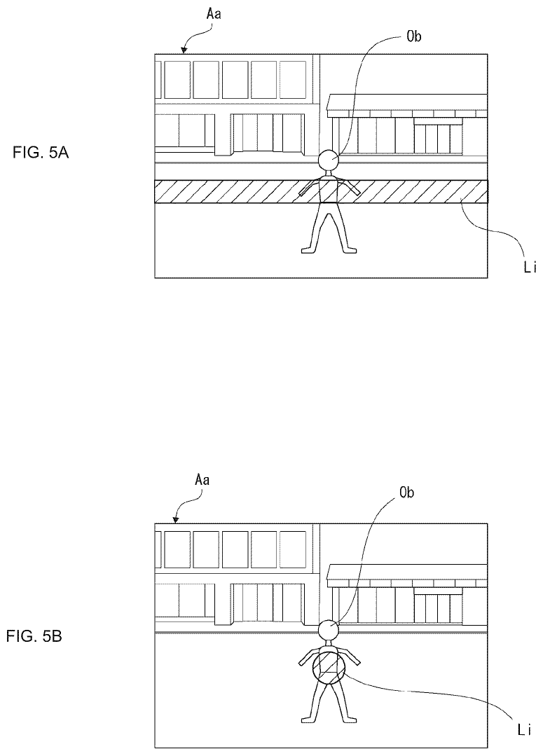

Note that, in the description above, an example has been described in which the irradiation light Li at the time of distance measurement of the target object Ob is vertically long light penetrating the distance measurable range Aa in the vertical direction. However, the irradiation light Li may be, for example, horizontally long light penetrating the distance measurable range Aa in a horizontal direction as illustrated in FIG. 5A, or may be non-penetrating light as illustrated in FIG. 5B. The non-penetrating light mentioned here means light that does not penetrate the distance measurable range Aa in the vertical direction and does not penetrate the distance measurable range Aa in the horizontal direction. For example, it is conceivable to use light that forms a round irradiation range as illustrated in FIG. 5B. Alternatively, it is also conceivable to use vertically long light or horizontally long light as the non-penetrating light. The vertically long light in this case is required not to penetrate the distance measurable range Aa at least in the longitudinal direction, and light may also be considered in which an irradiation range reaches one end portion in the vertical direction of the distance measurable range Aa, no only light in which an irradiation range does not reach any end portion in the vertical direction of the distance measurable range Aa. Similarly, the horizontally long light in this case is required not to penetrate the distance measurable range Aa at least in the horizontal direction, and light may also be adopted in which an irradiation range reaches one end portion in the horizontal direction of the distance measurable range Aa, in addition to light in which an irradiation range does not reach any end portion in the horizontal direction of the distance measurable range Aa.

For confirmation, the irradiation range of the irradiation light Li can be controlled by a configuration of an irradiation optical system for light emitted from the light emitting unit 10.

### 1-4. Processing Procedure

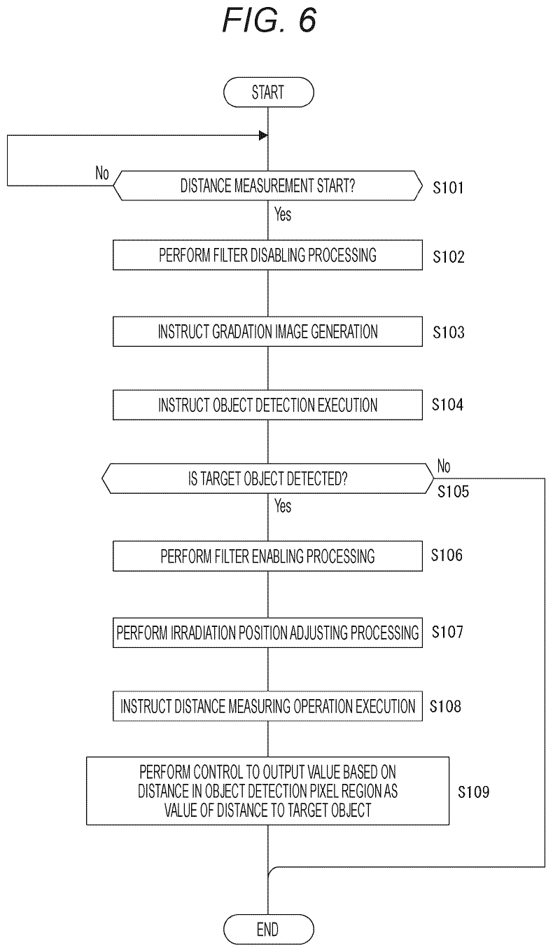

FIG. 6 is a flowchart illustrating a specific processing procedure example for implementing the distance measurement technique as the first embodiment described above. Specifically, FIG. 6 illustrates an example of a processing procedure to be executed by the control unit 13 illustrated in FIG. 1.

First, in step S101, the control unit 13 waits for a start of distance measurement. For example, step S101 is processing of waiting until a predetermined condition is satisfied as a condition for starting the distance measurement, such as an operation input instructing distance measurement from a user.

When the control unit 13 determines as a start the distance measurement, the control unit 13 proceeds to step S102, and performs processing of controlling the filter effect control unit 17 to the filter disabling mode as filter disabling processing.

Then, in step S103 subsequent to step S102, the control unit 13 issues a gradation image generation instruction. That is, the sensor unit 11 is caused to execute a light receiving operation (the same as the light receiving operation at the time of distance measurement), and causes the gradation image generation unit 14 to generate a gradation image on the basis of a charge signal for every floating diffusion FD obtained for every pixel Px by the light receiving operation.

By the processing of steps S102 and S103, the gradation image based on ambient light is generated.

In step S104 subsequent to step S103, the control unit 13 instructs the object detection unit 15 to execute object detection processing on the gradation image obtained in step S103, as an object detection execution instruction.

In step S105 subsequent to step S104, the control unit 13 determines whether or not the target object Ob is detected. That is, it is determined whether or not the target object Ob is detected by the object detection processing executed in step S104.

When the control unit 13 determines that the target object Ob is not detected, the control unit 13 ends the series of processing illustrated in FIG. 6. That is, in this case, since the target object Ob to be the distance measurement target is not detected, the distance measuring operation is not performed.

Whereas, when the control unit 13 determines that the target object Ob is detected, the control unit 13 proceeds to step S106 to perform processing of controlling the filter effect control unit 17 to the filter enabling mode as filter enabling processing, and then executes irradiation position adjusting processing of step S107. In the irradiation position adjusting processing in step S107, the control unit 13 first determines an irradiation position (irradiation target position) of the irradiation light Li on the basis of a position of the target object Ob detected in the object detection processing. Then, the control unit 13 causes the light emitting unit 10 to emit light and causes the beam steering unit 16 to adjust the irradiation position of the irradiation light Li so that the determined irradiation target position is irradiated with the irradiation light Li.

In step S108 subsequent to step S107, the control unit 13 issues a distance measuring operation execution instruction. That is, the sensor unit 11 is caused to execute the light receiving operation for distance measurement, and the distance calculation unit 12 is caused to calculate a distance based on a charge signal for every floating diffusion FD obtained for every pixel Px by the light receiving operation.

In step S109 subsequent to step S108, the control unit 13 performs control to output a value based on a distance in the object detection pixel region Ag as a value of the distance to the target object Ob.

As understood from the description above, in this example, the distance calculation unit 12 performs processing of obtaining a value based on a distance in the object detection pixel region Ag as the distance to the target object Ob. For example, as exemplified above, the distance calculation unit 12 performs processing of obtaining, as a value of the distance to the target object Ob, a value based on a distance calculated in the object detection pixel region Ag, such as processing of detecting a pixel Px having a light reception amount of a predetermined threshold value or more in the object detection pixel region Ag as a pixel Px that has received the reflected light Lr from the target object Ob on the basis of the charge signal for every floating diffusion FD input for pixel Px from the sensor unit 11, and obtaining an average value of distances calculated for the detected pixels Px as a value of the distance to the target object Ob.

In this case, the processing in step S109 is processing in which the control unit 13 outputs the value of the distance obtained by the distance calculation unit 12 to the outside of the distance calculation unit 12 as the value of the distance to the target object Ob.

Here, it is also conceivable that the distance calculation unit 12 does not have the function of obtaining the distance to the target object Ob as described above, but has only the function of calculating the distance for each pixel Px on the basis of the charge signal for every floating diffusion FD of each pixel Px input from the sensor unit 11. In that case, it is conceivable that the control unit 13 performs processing of obtaining the distance to the target object Ob on the basis of a distance for each pixel Px calculated by the distance calculation unit 12 and the charge signal for every floating diffusion FD of each pixel Px input from the sensor unit 11. Specifically, this is processing of obtaining, as the value of the distance to the target object Ob, a value based on a distance calculated in the object detection pixel region Ag, such as processing of detecting, as a pixel Px that has received reflected light Lr from the target object Ob, a pixel Px whose light reception amount is a predetermined threshold value or more in the object detection pixel region Ag on the basis of a charge signal for every floating diffusion FD, and obtaining an average value of the distances calculated for the detected pixels Px by the distance calculation unit 12 as the distance to the target object Ob.

In this case, the processing of step S109 is processing of outputting a value of a distance obtained by the control unit 13 itself as the distance to the target object Ob, to the outside as described above.

Note that, as described above, in a case where the control unit 13 performs the processing of obtaining the value of the distance to the target object Ob, it is not essential to input the charge signal and the distance for every floating diffusion FD for all the pixels Px to the control unit 13, and it is sufficient to input at least the charge signal and the distance for the pixels Px in the object detection pixel region Ag.

The control unit 13 ends the series of processing illustrated in FIG. 6 in response to the execution of the processing of step S109.

Here, in the description above, an example has been described in which the beam steering unit 16 that controls an irradiation position is provided for irradiation with the irradiation light Li as the active light at a position according to a detected position of the target object Ob, but it is not essential to provide the beam steering unit 16.

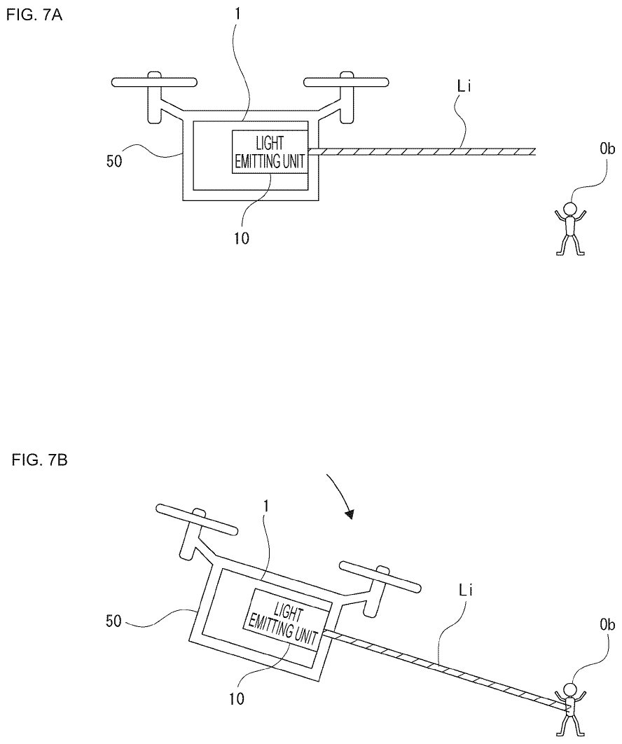

For example, in a case where the distance measuring device 1 is attached to an electronic device 50 such as a drone capable of adjusting an attitude as illustrated in FIG. 7A, the irradiation position of the irradiation light Li can be adjusted without the beam steering unit 16 provided, by controlling the attitude of the electronic device 50 (see the transition from FIG. 7A to FIG. 7B).

### 2. Second Embodiment

In the second embodiment, a sensor unit configured to be able to perform partial reading is used as a sensor unit that performs a light receiving operation for distance measurement. The partial reading mentioned here means that a light reception signal is read only for some pixels.

Hereinafter, as the sensor unit that can perform partial reading, a sensor unit 11A configured to be able to perform partial reading on a pixel region instructed from the outside and a sensor unit 11B configured to be able to perform event-based type partial reading such as an event based sensor (EVS) will be exemplified.

Here, the event-based type partial reading means selective reading of a light reception signal of a pixel in which an “event” as a change in light reception amount occurs.

Hereinafter, an example of using the sensor unit 11A will be described as a first example of the second embodiment, and an example of using the sensor unit 11B will be described as a second example of the second embodiment.

### 2-1. First Example

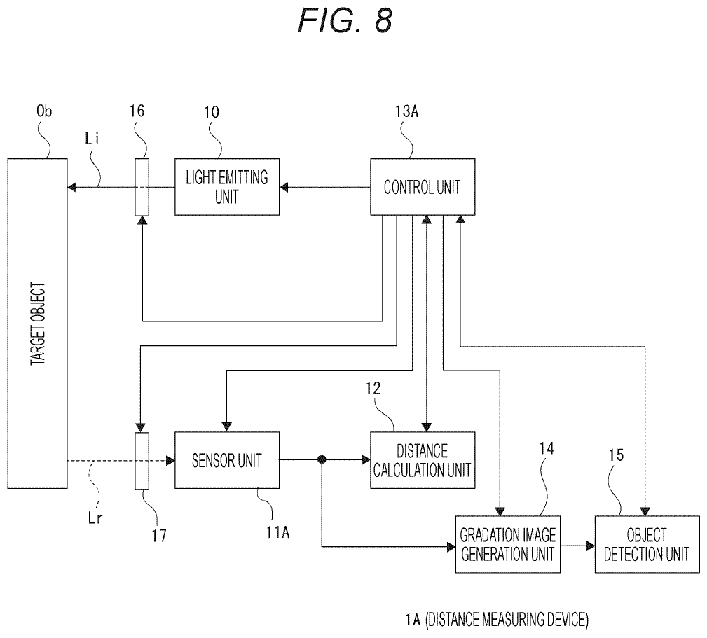

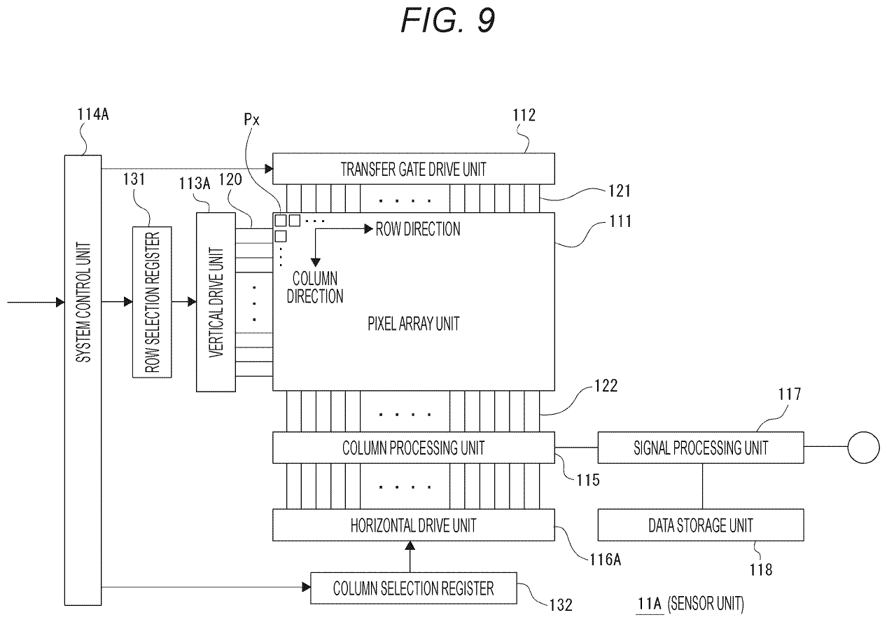

FIG. 8 is a block diagram for explaining a configuration example of a distance measuring device 1A as the first example of the second embodiment, and FIG. 9 is a block diagram illustrating an internal circuit configuration example of the sensor unit 11A included in the distance measuring device 1A.

Note that in the following description, the same reference numerals and the same step numbers will be used for parts similar to those already described, and the description thereof will be omitted.

In FIG. 8, the distance measuring device 1A is different from the distance measuring device 1 according to the first embodiment in that the sensor unit 11A is provided instead of the sensor unit 11, and a control unit 13A is provided instead of the control unit 13.

In FIG. 9, the sensor unit 11A is different from the sensor unit 11 (FIG. 2) in that a system control unit 114A is provided instead of the system control unit 114, a vertical drive unit 113A is provided instead of the vertical drive unit 113, and a horizontal drive unit 116A is provided instead of the horizontal drive unit 116, and that a row selection register 131 and a column selection register 132 are added.

When a pixel region (hereinafter referred to as a “readout target pixel region”) that should be subjected to partial reading is designated from the control unit 13A illustrated in FIG. 8, the system control unit 114A writes a row address of each pixel Px in the readout target pixel region into the row selection register 131.

The vertical drive unit 113A sequentially selects only a pixel row indicated by the row address written in the row selection register 131, instead of sequentially scanning all the pixel rows.

Furthermore, every time the vertical drive unit 113A selects one pixel row, the system control unit 114A sequentially writes a column address of the pixel Px in the readout target pixel region among the pixels Px in the pixel row, to the column selection register 132.

Every time the vertical drive unit 113A selects one pixel row, the horizontal drive unit 116A drives a column processing unit 115 such that the column processing unit 115 performs signal processing on a charge signal for only the pixel Px indicated by the column address written in the column selection register 132 (signal processing on a charge signal for every floating diffusion FD supplied through a vertical signal line 122).

For example, with the configuration described above, in a case where the control unit 13A designates only a part of the pixel region of the pixel array unit 111 as the readout target pixel region, the light reception signal can be read only for the part of the pixel region.

Note that, according to the configuration described above, it is also possible to perform full pixel reading by writing all the row addresses to the row selection register 131 and sequentially writing all the row addresses to the column selection register 132.

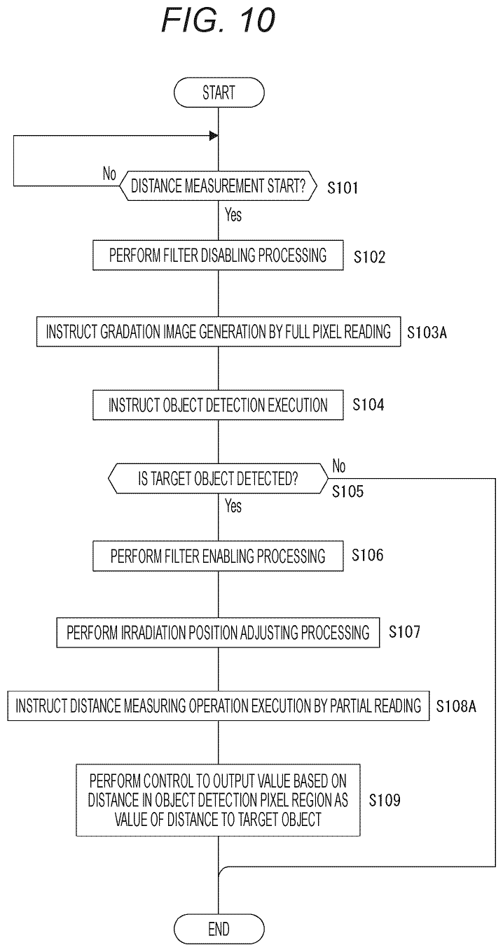

FIG. 10 is a flowchart illustrating a specific processing procedure example for implementing a distance measurement technique as the first example in the second embodiment. Specifically, an example of a processing procedure to be executed by the control unit 13A is illustrated.

First, the control unit 13A waits for a start of distance measurement in step S101, and performs filter disabling processing in step S102 when the control unit 13A determines as a start of the distance measurement.

Then, in subsequent step S103A, the control unit 13A issues a gradation image generation instruction by full pixel reading. That is, the control unit 13A instructs the system control unit 114A in the sensor unit 11A to cause the sensor unit 11A to execute full pixel reading by instructing the entire pixel region (entire effective pixel region) of the pixel array unit 111 as the above-described readout target pixel region, and causes a gradation image generation unit 14 to generate a gradation image on the basis of a charge signal for every floating diffusion FD of each pixel Px obtained by the full pixel reading.

After the issuing of the gradation image generation instruction in step S103A, processing from object detection execution instruction in step S104 to irradiation position adjusting processing in step S107 is executed, which is similar to the case of FIG. 6.

Note that the processing ends when it is determined in step S105 that a target object Ob has not been detected, which is also similar to the case of FIG. 6.

In response to the execution of the irradiation position adjusting processing in step S107, the control unit 13A issues a distance measuring operation execution instruction by partial reading in step S108A. Specifically, in step S108A, the control unit 13A first causes the sensor unit 11A to execute the light receiving operation for distance measurement, and causes the sensor unit 11A to execute partial reading for an object detection pixel region Ag by instructing the system control unit 114A with, as the readout target pixel region, the object detection pixel region Ag specified in the object detection processing executed in response to the instruction in step S104. Then, the distance calculation unit 12 is caused to calculate a distance based on the light reception signal of the object detection pixel region Ag subjected to partial reading, specifically, the charge signal for every floating diffusion FD.

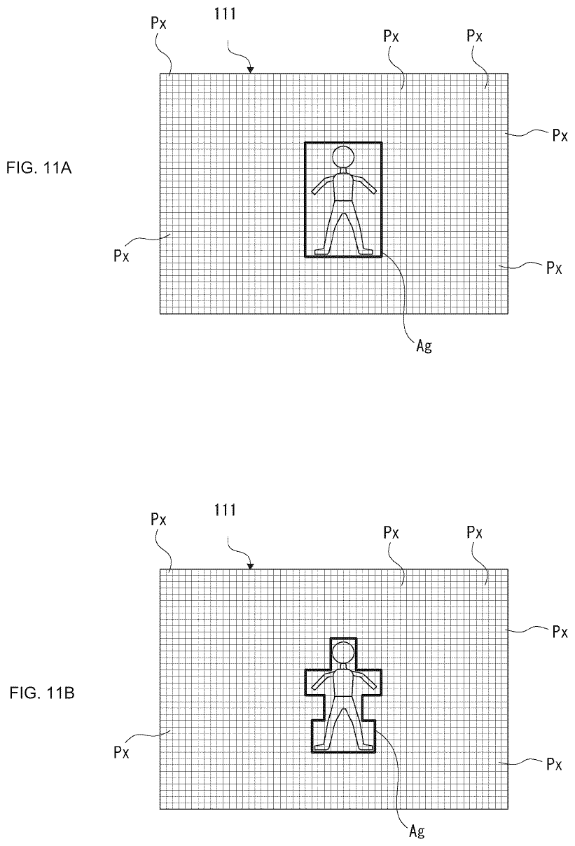

Here, an example of the object detection pixel region Ag will be described with reference to FIG. 11.

As the object detection pixel region Ag, for example, it is conceivable to set a rectangular region including the target object Ob as illustrated in FIG. 11A. The object detection pixel region Ag in this case does not faithfully reproduce a shape of the target object Ob, but has range setting with a relatively large margin including a surrounding region of the target object Ob.

Alternatively, as illustrated in FIG. 11B, the object detection pixel region Ag may have a shape reflecting the shape of the target object Ob to some extent instead of the quadrangular shape.

In any case, the object detection pixel region Ag is only required to be set as a pixel region including at least a part of the target object Ob.

According to the processing of step S108A, the sensor unit 11A performs partial reading using such an object detection pixel region Ag as the readout target pixel region.

In step S109 subsequent to step S108A, the control unit 13 performs control to output a value based on a distance in the object detection pixel region Ag as a value of the distance to the target object Ob.

The distance calculation unit 12 in this case performs processing of obtaining a distance to the target object Ob on the basis of a charge signal (charge signal for every floating diffusion FD) of each pixel Px in the object detection pixel region Ag subjected to partial reading in response to the instruction in step S108A. Specifically, in the object detection pixel region Ag, a pixel Px whose light reception amount is a predetermined threshold value or more is detected as a pixel Px that has received reflected light Lr from the target object Ob, and an average value of distances calculated for the detected pixels Px is obtained as the distance to the target object Ob.

Alternatively, a pixel Px having the largest light reception amount in the object detection pixel region Ag is detected, and a distance calculated for the pixel Px is set as the distance to the target object Ob, for example.

In a case where the distance calculation unit 12 performs processing of obtaining a value based on a distance calculated in the object detection pixel region Ag as a value of the distance to the target object Ob as described above, the processing in step S109 is processing in which the control unit 13 outputs the value of the distance obtained by the distance calculation unit 12 to the outside of the distance calculation unit 12 as the value of the distance to the target object Ob.

Alternatively, it is also conceivable that the processing of obtaining the value of the distance to the target object Ob is performed by the control unit 13A on the basis of a charge signal of each pixel Px in the object detection pixel region Ag subjected to partial reading from the sensor unit 11A and a distance for each pixel Px in the object detection pixel region Ag calculated by the distance calculation unit 12. That is, for example, this is processing of detecting, as a pixel Px that has received the reflected light Lr from the target object Ob, a pixel Px whose light reception amount is a predetermined threshold value or more in the object detection pixel region Ag on the basis of a charge signal for every floating diffusion FD, and obtaining an average value of distances calculated for the detected pixels Px by the distance calculation unit 12 as the distance to the target object Ob.

In this case, the processing of step S109 is processing of outputting a value of a distance obtained by the control unit 13A itself as the distance to the target object Ob, to the outside as described above.

The control unit 13A ends the series of processing illustrated in FIG. 10 in response to the execution of the processing of step S109.

### 2-2. Second Example

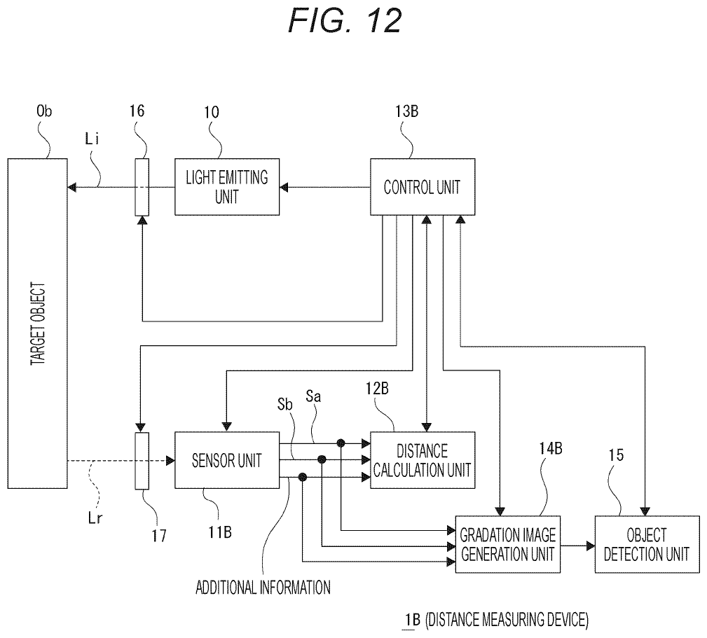

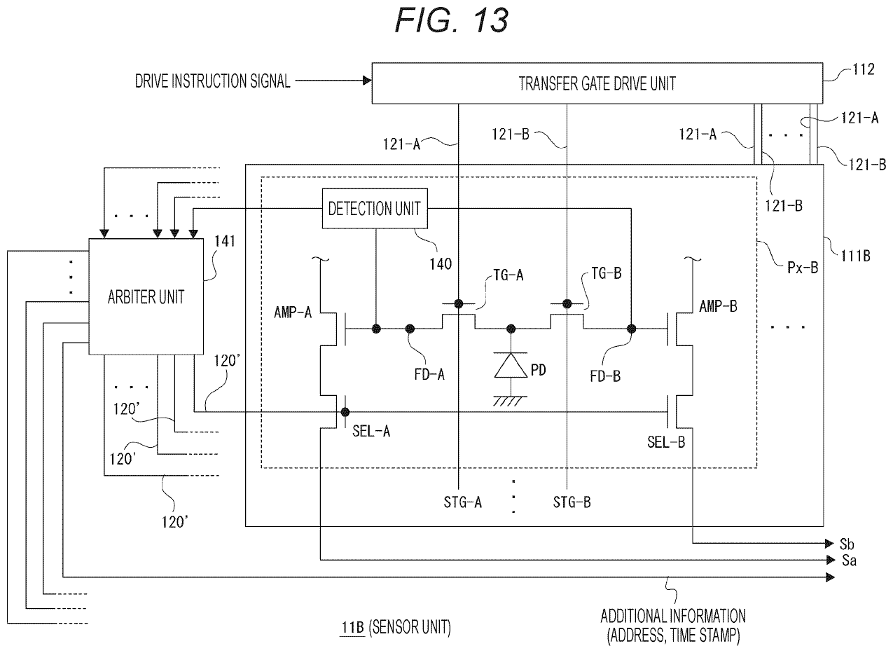

FIG. 12 is a block diagram for explaining a configuration example of a distance measuring device 1B as the second example of the second embodiment, and FIG. 13 is a block diagram illustrating an internal circuit configuration example of the sensor unit 11B included in the distance measuring device 1B.

In FIG. 12, the distance measuring device 1B is different from the distance measuring device 1 according to the first embodiment in that the sensor unit 11B is provided instead of the sensor unit 11, a distance calculation unit 12B is provided instead of the distance calculation unit 12, a gradation image generation unit 14B is provided instead of the gradation image generation unit 14, and a control unit 13B is provided instead of the control unit 13.

As illustrated in FIG. 13, the sensor unit 11B includes a pixel array unit 111B, a transfer gate drive unit 112, and an arbiter unit 141.

The pixel array unit 111B is formed by arranging a plurality of pixels Px-B individually in a row direction and a column direction. Unlike the pixel array unit 111, vertical signal lines 122-A and 122-B are not formed in the pixel array unit 111B.

The pixel Px-B is different from the pixel Px (see FIG. 3) in that a detection unit 140 is added.

Note that, in FIG. 13, for a configuration in the pixel Px-B, reset transistors RST-A and RST-B, an OF gate transistor OFG, and supply lines of an OF gate signal SOFG and a reset signal SRST are not illustrated. In this case, the reset transistors RST-A and RST-B and the OF gate transistor OFG are driven by a drive circuit (not illustrated).

Also in this case, the transfer gate drive unit 112 supplies transfer drive signals STG-A and STG-B through gate drive lines 121-A and 121-B, respectively, to drive transfer transistors TG-A and TG-B.

The transfer gate drive unit 112 in this case drives the transfer transistors TG-A and TG-B on the basis of a drive instruction signal from the outside. In this example, the drive instruction signal is supplied from the control unit 13B.

The detection unit 140 detects, as an event, that an active light intensity obtained from accumulated charge amounts of both the floating diffusion FD-A and the FD-B is larger than a predetermined threshold value. Specifically, the detection unit 140 calculates a square sum of the accumulated charge amounts of both the floating diffusion FD-A and the FD-B, and obtains a detection result that an event has occurred when the square sum is a threshold value or more. Note that the calculation of the active light intensity is not limited to the above-described calculation by using the square sum, and may be, for example, calculation by a sum or a difference of the accumulated charge amounts of both the floating diffusion FD-A and the FD-B.

When an event is detected, the detection unit 140 gives an event occurrence notification to the arbiter unit 141.

The arbiter unit 141 is configured to be able to input the event occurrence notification from the detection unit 140 in each pixel Px-B, and performs control such that a charge signal of each floating diffusion FD for the pixel Px-B for which the event occurrence notification has been given, that is, a charge signal Sa of the floating diffusion FD-A and a charge signal Sb of the floating diffusion FD-B are read. Specifically, the charge signals Sa and Sb are read by driving selection transistors SEL-A and SEL-B through a pixel drive line 120′ for the pixel Px-B for which the event occurrence notification has been given.

Furthermore, the arbiter unit 141 also outputs, for the pixel Px-B for which the event occurrence notification has been given, additional information including a time stamp (information indicating an event occurrence timing) for the event that has occurred and information about an address of the pixel Px-B for which the event has occurred.

With the configuration as described above, in the sensor unit 11B, the charge signals Sa and Sb of the pixel in which the “event” has occurred can be selectively read. Further, for the pixel Px-B in which the event has occurred, information about the address and the time stamp of the pixel Px is output as the additional information.

In FIG. 12, the charge signals Sa and Sb and the additional information from the sensor unit 11B are input to the distance calculation unit 12B and the gradation image generation unit 14B.

The gradation image generation unit 14B generates a gradation image for an event-occurring pixel region, which is a pixel region where an event has occurred, on the basis of the charge signals Sa and Sb and the additional information that have been input.

In this case, the object detection unit 15 performs object detection processing on, as a target, the gradation image of the event-occurring pixel region generated by the gradation image generation unit 14B.

The distance calculation unit 12B calculates a distance for the pixel Px-B in the event-occurring pixel region on the basis of the gradation signals Sa and Sb and the additional information that have been input from the sensor unit 11B. The distance calculation unit 12B in this example is configured to be able to calculate a distance for each pixel Px-B in the event-occurring pixel region.

The control unit 13B performs control such that a value based on the distance in the object detection pixel region Ag is output as the value of the distance to the target object Ob, on the basis of the object detection result obtained by the object detection unit 15.

Specifically, the processing executed by the control unit 13B in this case for measuring the distance to the target object Ob is similar to that illustrated in FIG. 6 above.

Also in this case, as the processing in step S109, a mode is conceivable in which the processing of obtaining a value based on a distance calculated in the object detection pixel region Ag as a value of the distance to the target object Ob is executed by the distance calculation unit 12B or executed by the control unit 13B itself.

Note that the control unit 13B outputs the above-described drive instruction signal to the transfer gate drive unit 112 when causing the sensor unit 11B to execute the light receiving operation at the time of the gradation image generation instruction in step S103 or the distance measuring operation execution instruction in step S108.

### 3. Third Embodiment

Next, a third embodiment will be described.

In the third embodiment, a baseline distance Db between a light emitting optical system of irradiation light Li and a light receiving optical system of reflected light Lr is considered.

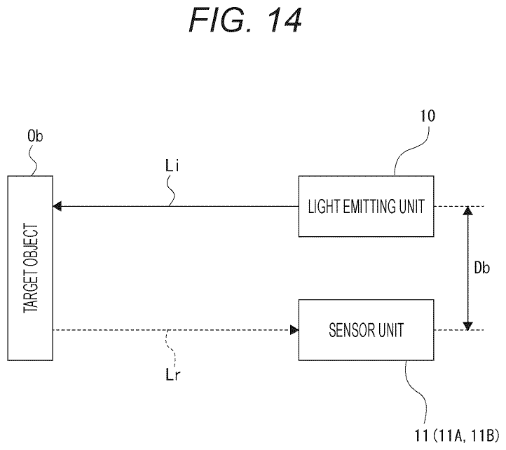

As schematically illustrated in FIG. 14, an optical system for irradiating a target object Ob with light emitted from a light emitting unit 10 as the irradiation light Li and an optical system for causing a sensor unit 11 (11A, 11B) to receive the reflected light Lr from the target object Ob are located at physically different positions, and the baseline distance Db exists therebetween. Therefore, strictly speaking, a target irradiation position (irradiation angle) for irradiating the target object Ob with the irradiation light Li should be changed according to a distance between the target object Ob and the distance measuring device 1 (1A, 1B).

However, since a distance to the target object Ob is obviously unknown before distance measurement of the target object Ob, it is very difficult to accurately set the target irradiation position according to the distance to the target object Ob.

Therefore, in the third embodiment, whether or not reflected light is received is evaluated for every irradiation position while changing the irradiation position of the irradiation light Li in a partial region including an object detection region in a distance measurable range Aa, and the distance to the target object Ob is calculated on the basis of a light reception signal of the time when the reflected light is received.

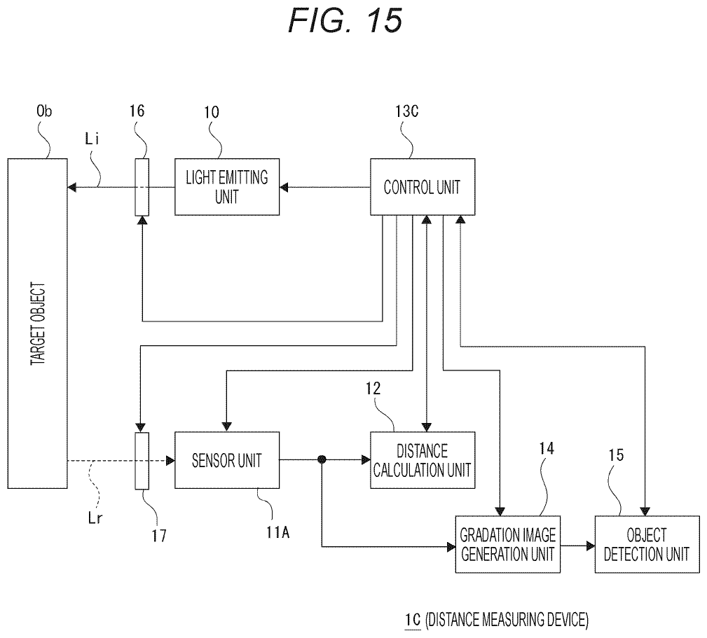

FIG. 15 is a block diagram for explaining a configuration example of a distance measuring device 1C as the third embodiment.

Here, as the distance measuring device 1C of the third embodiment, a configuration including a sensor unit 11A is exemplified similarly to the distance measuring device 1A illustrated in FIG. 8. That is, the configuration corresponds to partial reading.

The distance measuring device 1C is different from the distance measuring device 1A illustrated in FIG. 8 in that a control unit 13C is provided instead of the control unit 13A.

The control unit 13C is different from the control unit 13A in that control is performed such that distance measurement of the target object Ob is performed by a distance measurement technique as the third embodiment described below.

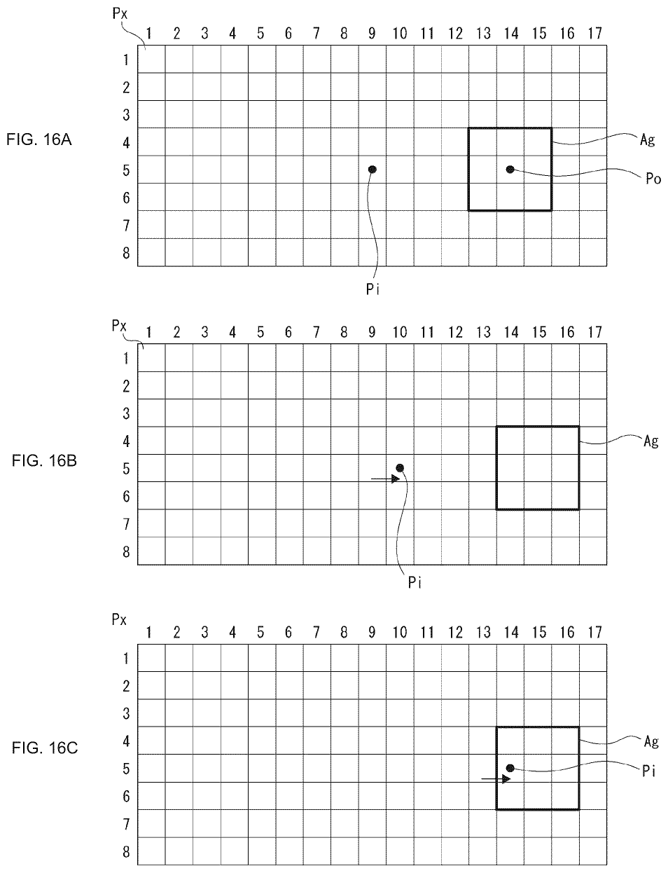

FIG. 16 is an explanatory diagram of the distance measurement technique as the third embodiment.

FIG. 16A schematically illustrates an example of a relationship between the object detection pixel region Ag, an object detection pixel position Po, and an irradiation position Pi of the irradiation light Li. The object detection pixel position Po is a pixel position of the target object Ob detected in the object detection processing, and is, for example, a position detected as a center position or the like of the object detection pixel region Ag in up-down and left-right directions.

Here, a description will be given on the assumption that irradiation is performed with circular non-penetrating light (light of a non-penetrating type) as illustrated in FIG. 5B, as the irradiation light Li.

In the third embodiment, first, the irradiation position Pi is adjusted to an initial irradiation position in response to detection of the target object Ob by the object detection unit 15. In this example, the initial irradiation position is determined at a position corresponding to a pixel coordinate in which an ordinate is the same as the object detection pixel position Po and an abscissa is a central coordinate.

In the figure, since the ordinate of the object detection pixel position Po is “5” and the central coordinate of the abscissa is “9”, the initial irradiation position is adjusted to a position corresponding to the pixel coordinates of (9, 5).

After adjusting the irradiation position Pi to the initial irradiation position, the control unit 13C causes the sensor unit 11A to execute the light receiving operation for distance measurement with the object detection pixel region Ag as a readout target range. Then, whether or not the reflected light Lr from the target object Ob is received in the object detection pixel region Ag is evaluated on the basis of a charge signal for every floating diffusion FD obtained in the light receiving operation. In this evaluation, it is conceivable that the control unit 13C calculates a light reception amount of each pixel Px in the object detection pixel region Ag on the basis of a charge signal for every floating diffusion FD subjected to partial reading by the sensor unit 11A, and specifies a pixel Px whose light reception amount is a predetermined threshold value or more as a pixel Px that has received the reflected light Lr.

Alternatively, it is also conceivable that the distance calculation unit 12 is caused to calculate the light reception amount of each pixel Px in the object detection pixel region Ag, and the control unit 13C specifies a pixel Px that has received the reflected light Lr on the basis of the threshold value described above on the basis of information about the calculated light reception amount.

In a case where it is evaluated that there is no pixel Px in which the reflected light Lr is received in the object detection pixel region Ag at the initial irradiation position, the control unit 13C updates the irradiation position Pi of the irradiation light Li. Specifically, in this example, a lateral position of the irradiation position Pi is updated in a direction approaching the object detection pixel position Po among left and right directions (see FIG. 16B). Here, for convenience of description, an update width of the lateral position is one pixel width, but the update width may be a width for a plurality of pixels.

Also in a case where the irradiation position Pi is updated in this manner, the control unit 13C similarly causes the sensor unit 11A to execute the light receiving operation for distance measurement in which the object detection pixel region Ag is set as the readout target range, to evaluate whether or not the reflected light Lr from the target object Ob is received in the object detection pixel region Ag.

Thereafter, when the control unit 13C evaluates that there is no pixel Px that has received the reflected light Lr in the object detection pixel region Ag, the control unit 13C similarly updates the irradiation position Pi, and causes the sensor unit 11A to execute the light receiving operation for distance measurement with the object detection pixel region Ag as the readout target range at the irradiation position Pi after the update, to evaluate whether or not the reflected light Lr from the target object Ob is received in the object detection pixel region Ag.

FIG. 16C illustrates a state in which the above-described update of the lateral position of the irradiation position Pi is continued, and the irradiation position Pi is changed to a position corresponding to the pixel Px in the object detection pixel region Ag.

When the control unit 13C evaluates that the reflected light Lr from the target object Ob is received in the object detection pixel region Ag, the control unit 13C performs control such that a value based on a distance in the object detection pixel region Ag calculated by the distance calculation unit 12 in the setting state of the irradiation position Pi is output as the value of the distance to the target object Ob.

For example, when the control unit 13C evaluates that the reflected light Lr from the target object Ob is received in the object detection pixel region Ag, on the basis of a gradation signal of each pixel Px in the object detection pixel region Ag read from the sensor unit 11A by the light receiving operation executed in the setting state of the irradiation position Pi of the time when the evaluation is performed, the control unit 13C specifies a pixel Px whose light reception amount is a predetermined threshold value or more in the object detection pixel region Ag as a pixel Px that has received the reflected light Lr, and outputs an average value of distances calculated by the distance calculation unit 12 for the specified pixels Px as the distance value of the target object Ob.

Alternatively, the specification of the pixel Px that has received the reflected light Lr and the calculation of the average value of the distances for the specified pixel Px may be executed by the distance calculation unit 12. In that case, the control unit 13C performs processing of outputting the average value calculated in this manner to the outside of the distance calculation unit 12 as the value of the distance to the target object Ob.

Note that, since the specification of the pixel Px that has received the reflected light Lr is executed at the stage of evaluation, it is not necessary to perform the specification again after the evaluation.

Here, in a case of updating the irradiation position Pi from the initial irradiation position to the object detection pixel position Po side as described above, it is also conceivable that the reflected light Lr is not received in the object detection pixel region Ag for some reason, and the irradiation position Pi is updated to an end position in the horizontal direction.

In a case where the irradiation position Pi is updated to the horizontal end position in this manner, and it is evaluated that there is no pixel Px that has received the reflected light Lr even at the horizontal end position, the control unit 13C updates the irradiation position Pi from the horizontal end position on the opposite side toward the horizontal central position.

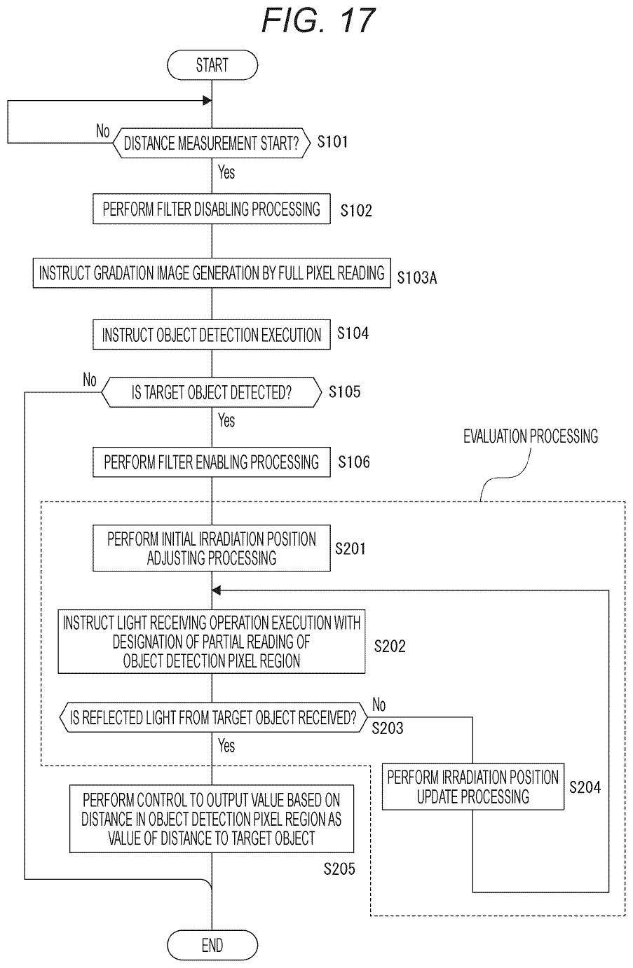

FIG. 17 is a flowchart illustrating a specific processing procedure example for implementing the distance measurement technique as the third embodiment described above.

First, the control unit 13C also executes the processing of steps S101, S102, S103A, S104, S105, and S106 described above with reference to FIG. 10.

The control unit 13C executes initial irradiation position adjusting processing in step S201 in response to execution of the filter enabling processing in step S106. That is, the beam steering unit 16 is controlled to set the irradiation position of the irradiation light Li to the initial irradiation position described above.

In step S202 subsequent to step S201, as a light receiving operation execution instruction designating partial reading of the object detection pixel region Ag, the control unit 13C instructs the sensor unit 11A to execute a light receiving operation for distance measurement with the object detection pixel region Ag as a readout target range.

In step S203 subsequent to step S202, the control unit 13C determines whether or not the reflected light Lr from the target object Ob is received. In this determination, it is conceivable that the control unit 13C calculates a light reception amount of each pixel Px in the object detection pixel region Ag on the basis of a charge signal for every floating diffusion FD subjected to partial reading by the sensor unit 11A, to specify a pixel Px whose light reception amount is a predetermined threshold value or more as a pixel Px that has received the reflected light Lr.

Alternatively, it is also conceivable that the distance calculation unit 12 is caused to calculate the light reception amount of each pixel Px in the object detection pixel region Ag, and the control unit 13C specifies a pixel Px that has received the reflected light Lr on the basis of the threshold value described above on the basis of information about the calculated light reception amount.

When at least one pixel Px that has received the reflected light Lr is specified, the control unit 13C obtains a determination result that the reflected light Lr from the target object Ob is received. In other cases, the control unit 13C obtains a determination result that the reflected light Lr from the target object Ob is not received.

When the control unit 13C determines in step S203 that the reflected light Lr from the target object Ob is not received, the control unit 13C proceeds to step S204, executes irradiation position update processing, and returns to step S202. As can be understood from the description above, in the update processing of step S204, the irradiation position Pi is updated in a direction approaching the object detection pixel position Po among left and right directions from the initial irradiation position. Then, when the current irradiation position Pi reaches a horizontal end position by such irradiation position update, the irradiation position Pi is updated to the horizontal end position on the opposite side, and the irradiation position Pi is updated toward the initial irradiation position in the subsequent update processing.

When the light receiving operation execution instruction in step S202 is issued after the update processing in step S204, for the new irradiation position Pi, the light receiving operation (S202) with the object detection pixel region Ag as the target read range and the evaluation of the presence or absence of reception of the reflected light Lr based on a charge signal obtained by the light receiving operation (S203) are performed.

Here, the loop processing of steps S202-S203-S204-S202 corresponds to an example of “evaluation processing” in the present technology.

When the control unit 13C determines in step S203 that the reflected light Lr from the target object Ob is received, the control unit 13C proceeds to step S205 and performs control to output a value based on a distance in the object detection pixel region Ag as a value of the distance to the target object Ob.

Specifically, the control unit 13C performs processing of outputting an average value of distances for the pixels Px as the value of the distance to the target object Ob for a “pixel Px that has received the reflected light Lr” specified as a pixel Px whose light reception amount is the predetermined threshold value or more. Alternatively, the specification of the pixel Px that has received the reflected light Lr and the calculation of the average value of the distances for the specified pixel Px may be executed by the distance calculation unit 12. In that case, as the processing of step S205, the control unit 13C performs processing of outputting the average value calculated in this manner to the outside of the distance calculation unit 12 as the value of the distance to the target object Ob.

In response to the execution of the processing of step S205, the control unit 13C ends the series of processing illustrated in FIG. 17.

Here, in the third embodiment, the partial reading as in the second embodiment is adopted, which makes it possible to reduce power consumption of the sensor unit 11A in executing the evaluation processing.

Furthermore, by adopting the partial reading, it is possible to reduce motion blur in a case where the target object Ob moves or in a case where a view angle of distance measurement changes. Furthermore, a processing speed can be increased by the partial reading.

Although the example of using the sensor unit 11A has been described above as an example of the partial reading, a distance measuring operation in consideration of the baseline distance Db can be implemented by a similar technique also in a case of using the event-based type sensor unit 11B.

In a case of using the event-based type sensor unit 11B, it is possible to evaluate whether or not the reflected light Lr from the target object Ob is received in the object detection pixel region Ag on the basis of whether or not a light reception signal is read in the sensor unit 11B. Specifically, the control unit 13C in this case causes the sensor unit 11B to execute the light receiving operation for distance measurement for every irradiation position, and evaluates whether or not the reflected light Lr from the target object Ob is received in the object detection pixel region Ag on the basis of whether or not a signal has been read from the sensor unit 11B for the pixel Px-B in the object detection pixel region Ag.

By using the sensor unit 11B, it is possible to prevent the light reception signal reading by the sensor unit 11B from being performed unless the target object Ob is irradiated with the irradiation light Li at the time of the evaluation processing.

Therefore, according to the configuration described above, it is possible to reduce power consumption of the sensor unit 11B at the time of evaluation processing. Moreover, in order to improve distance measurement accuracy with respect to the baseline distance Db, it is not necessary to issue a partial reading instruction to the sensor unit 11B at the time of evaluation processing. Therefore, it is possible to reduce a processing load on a control processor (the control unit 13C in this example) included in the distance measuring device 1C.

Moreover, a processing speed can be increased by the partial reading.

Note that the updating technique of the irradiation position Pi is not limited to the updating from the horizontal central position as exemplified above.

For example, in a case where the object detection pixel position Po is located shifted to either the left or the right with respect to the center pixel position, it is also conceivable to update the irradiation position Pi in a direction approaching the object detection pixel position Po by using, as the initial irradiation position, a horizontal end position on a side opposite to a side where the object detection pixel position Po is present. Alternatively, conversely, it is also conceivable to update the irradiation position Pi in a direction approaching the object detection pixel position Po by using, as the initial irradiation position, a horizontal end position on the side where the object detection pixel position Po is present.

Furthermore, an example has been described above in which the update width of the irradiation position Pi is fixed, but the update width of the irradiation position Pi may be variable according to a predetermined condition such as a separation distance from the object detection pixel position Po. As an example, it is conceivable to increase the update width as the separation distance from the object detection pixel position Po increases, for example.

Note that the distance measurement technique in consideration of the baseline distance Db as in the third embodiment can also be suitably applied to the case of using the sensor unit 11 that performs full reading as in the first embodiment.

### 4. Modification

Note that, the embodiments are not limited to the specific examples described above, and may have configurations as various modifications.

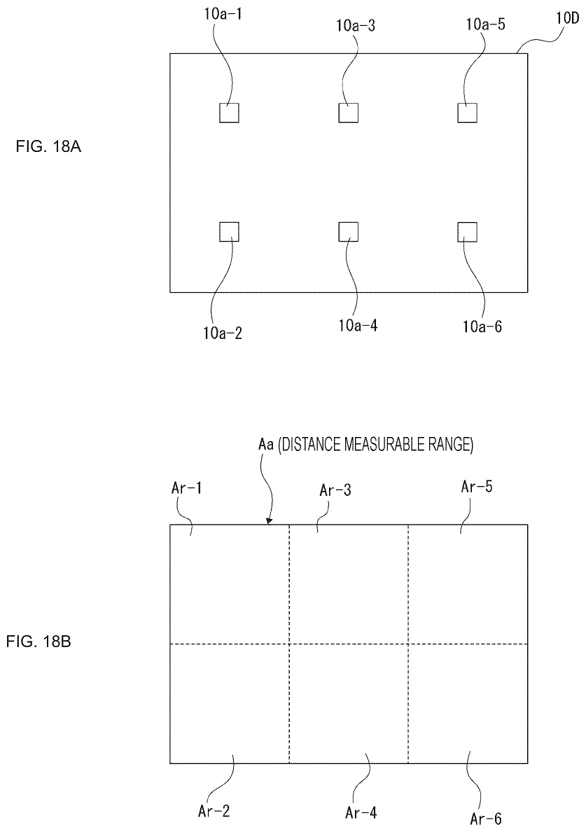

For example, in the description above, an example has been described in which light emitted from the light emitting unit 10 as a single light source is used for irradiation as the irradiation light Li, but the light emitting unit of the irradiation light Li can also be formed as a light emitting unit 10D having a plurality of light emitting elements 10a as illustrated in FIG. 18A.

Then, in a case of using such a light emitting unit 10D, it is conceivable that individual light emitting elements 10a irradiate different irradiation areas Ar in the distance measurable range Aa with the irradiation light Li.

Specifically, FIG. 18B illustrates an example in which the distance measurable range Aa is sectioned into six irradiation areas Ar (Ar-1, Ar-2, Ar-3, Ar-4, Ar-5, and Ar-6). However, in this case, as illustrated in FIG. 18A, as the light emitting unit 10D, six light emitting elements 10a (10a-1, 10a-2, 10a-3, 10a-4, 10a-5, and 10a-6) are provided, and each light emitting element 10a performs irradiation with the irradiation light Li covering one corresponding irradiation area Ar.

In this case, the irradiation position of the irradiation light Li is adjusted by a technique of irradiating only the target irradiation area Ar with the irradiation light Li among the plurality of irradiation areas Ar. Specifically, the adjustment of the irradiation position in this case is performed by causing only the light emitting element 10a in charge of the target irradiation area Ar to emit light among the plurality of light emitting elements 10a in the light emitting unit 10D.

In a case where the irradiation position of the irradiation light Li is adjusted depending on which light emitting element 10a is caused to emit light in this manner, by adopting the distance measurement technique as the embodiment, it is sufficient to cause only the light emitting element 10a in the irradiation area Ar corresponding to the detected position of the target object Ob to emit light at the time of distance measurement, which makes it possible to reduce power consumption in distance measurement.

Note that, an example has been described above in which one light emitting element 10a is provided for one irradiation area Ar, but a plurality of light emitting elements 10a may be provided for one irradiation area Ar.

Furthermore, in the description above, an example has been described in which an IR filter is provided in the light receiving optical system of the reflected light Lr, but this is not essential. Even in a case where the IR filter is not provided, for example, by increasing intensity of the irradiation light Li at the time of distance measurement, an S/N ratio can be increased even if ambient light (noise component) is received, and it is possible to suppress a decrease in distance measurement accuracy due to the absence of the IR filter.

Furthermore, in the description above, an example has been described in which irradiation with the irradiation light Li is not performed at the time of obtaining a gradation image to be used for the object detection processing. However, for example, in a dark environment such as nighttime, it is also conceivable to generate a gradation image by performing irradiation with the irradiation light Li. At this time, it is conceivable that the irradiation light Li for generating the gradation image is illumination light by a light source (for example, a light emitting diode (LED) or the like) different from the light emitting unit 10 (or 10D). Alternatively, even if the light source is not a separate light source, for example, a technique of using a means for diffusing light from the light emitting unit 10 to obtain illumination light for generating the gradation image may be considered.

Furthermore, in the description above, an example has been described in which object detection is performed on the basis of only a sensing image obtained by the sensor unit 11 (11A, 11B) as the indirect ToF sensor. However, the object detection can also be performed as fusion processing using a sensing image obtained by the indirect ToF sensor and a sensing image obtained by a different sensor unit provided separately from the indirect ToF sensor.

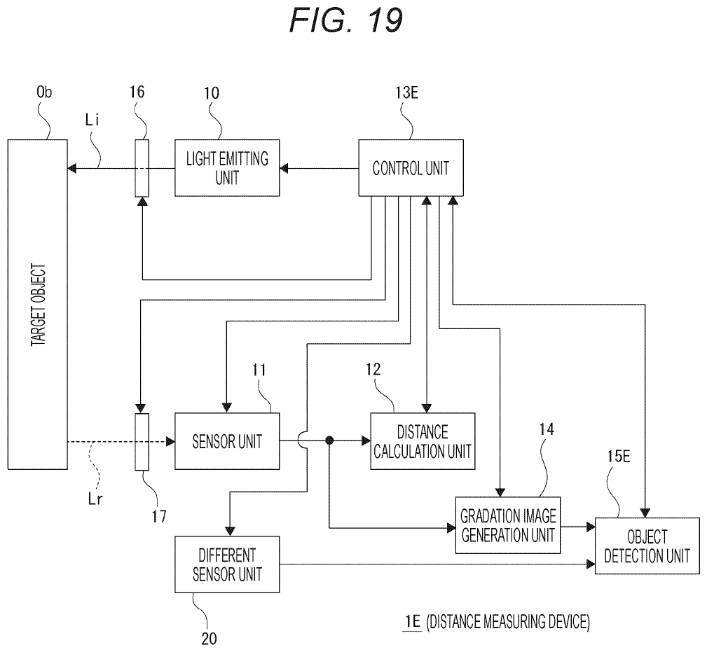

FIG. 19 is a block diagram for explaining a configuration example of a distance measuring device 1E as a modification that performs object detection processing as such fusion processing.

The distance measuring device 1E is different from the distance measuring device 1 in that a different sensor unit 20 is added, and that an object detection unit 15E and a control unit 13E are provided instead of the object detection unit 15 and the control unit 13, respectively.

The different sensor unit 20 is a sensor unit that obtains a sensing image whose type is different from that of the sensor unit 11. Examples of the different sensor unit 20 include, for example, a gradation image sensor that detects a light reception amount for every pixel such as an RGB sensor, a thermal image sensor that detects temperature information for every pixel, a multispectrum image sensor that obtains a multispectrum image indicating light reception amount information for a plurality of wavelengths for every pixel, and a polarization image sensor that detects polarization information for every pixel. In this case, as the gradation image sensor, it is conceivable to use a sensor having a larger number of pixels than the sensor unit 11 (that is, a higher resolution image can be obtained as a gradation image). Alternatively, as the gradation image sensor, it is also conceivable to use a sensor whose number of pixels is equal to or less than the number of pixels of the sensor unit 11.

The “obtaining a sensing image whose type is different” mentioned here includes not only a difference in image characteristics such as, for example, a distance image, a gradation image, a thermal image, a multi-spectrum image, and a polarized image, but also a difference in image resolution.

The different sensor unit 20 may be of any specific sensor type as long as the definition of “obtaining a sensing image whose type is different” is satisfied.

The object detection unit 15E performs object detection processing on the basis of a gradation image generated by the gradation image generation unit 14 and a sensing image obtained by the different sensor unit 20.

The control unit 13E is different from the control unit 13 in that the control unit 13E causes not only the sensor unit 11 but also the different sensor unit 20 to execute a sensing operation when the object detection unit 15E detects an object.

According to the distance measuring device 1E as described above, it is possible to perform the object detection processing by sensor fusion processing using not only the gradation image obtained by the sensor unit 11 but also the sensing image obtained by the different sensor unit.

Therefore, accuracy of the object detection processing can be improved as compared with a case where the object detection processing is performed on the basis of only a sensing image obtained by a single sensor unit, and accuracy of the distance measurement performed on the basis of an object detection result can be improved.

Note that, it is not essential to use a gradation image obtained by the indirect ToF sensor for the object detection processing.

Specifically, the object detection processing is performed on the basis of only an image obtained by “a different sensor unit that obtains an image whose type is different” such as a high-resolution RGB sensor.

For example, by using the high-resolution RGB sensor, the object detection processing based on an image higher in resolution than that of the indirect ToF sensor is performed, so that accuracy of the object detection can be improved and distance measurement accuracy of the target object can be improved.

Furthermore, in the description above, an example in which the indirect ToF sensor is used as the distance measuring sensor has been described. However, the present technology can be widely and suitably applied to a case where a sensor compatible with distance measurement by the ToF method, such as a sensor compatible with a direct ToF method, is used as the distance measurement sensor.

Furthermore, in the description above, an example has been described in which the VCSEL is used as the light source of the light emitting unit 10, but the present technology can also be suitably applied to a case where another light emitting element such as a semiconductor laser other than the VCSEL or an LED is used as the light source.

### 5. Summary of Embodiment

As described above, a first distance measuring device (first distance measuring device 1, 1A, 1B, 1C, 1E) as the embodiment includes: a light emitting unit (light emitting unit 10, 10D) configured to emit light; a sensor unit (sensor unit 11, 11A, 11B) configured to perform a light receiving operation for distance measurement by a ToF method, for reflected light obtained when an object reflects light emitted from the light emitting unit; a calculation unit (distance calculation unit 12, 12B) configured to calculate a distance by the ToF method on the basis of a light reception signal of the sensor unit; an object detection unit (object detection unit 15, 15E) configured to perform object detection processing on the basis of a sensing image obtained by sensing on a distance measurable range that is a view angle range in which distance measurement can be performed using the sensor unit; and a control unit (control unit 13, 13A, 13B, 13C, 13E) configured to control the calculation unit to calculate a distance to a target object on the basis of a light reception signal obtained by the sensor unit when a position according to a position of the target object detected by the object detection unit is irradiated with light emitted by the light emitting unit.

According to the configuration described above, it is possible to calculate a distance to the target object by irradiating, with the active light, not the entire distance measurable range but only a part according to a position where the target object is present.

Therefore, it is possible to intensively irradiate a partial range with light with which the entire distance measurable range should originally be diffusely irradiated, and it is possible to enhance the reflected light from the target object and to improve distance measurement accuracy.

Alternatively, in a case where a configuration is assumed in which the entire distance measurable range is irradiated using a plurality of light sources, it is sufficient to cause light emission by only a light source that irradiates a partial range in which the target object is present, and power consumption in the distance measurement can be reduced.

Furthermore, since the distance to the target object can be calculated by irradiating only a part according to the position where the target object is present with the active light, it is possible to increase a speed of distance measuring processing.

Furthermore, in the first distance measuring device as the embodiment, the object detection unit performs the object detection processing on the basis of a gradation image generated on the basis of a light reception signal of the sensor unit.

According to the configuration described above, a sensor used for distance measurement and a sensor used for object detection processing are unified.

Therefore, it is possible to eliminate the need to separately provide a sensor for object detection, and it is possible to reduce the number of parts, reduce a size and a weight of the distance measuring device, and reduce the cost.

Furthermore, since a sensor used for distance measurement and a sensor used for object detection processing are unified, it is not necessary to perform image alignment as in a case where a separate sensor for object detection is used, and it is possible to prevent distance measurement accuracy from deteriorating depending on accuracy of alignment processing, and to improve distance measurement accuracy.

Moreover, in the first distance measuring device as the embodiment, the control unit causes the object detection unit to execute the object detection processing on a gradation image obtained by causing the sensor unit to execute a light receiving operation in a state where the light emitting unit does not emit light.

As a result, the object detection processing is performed on a gradation image obtained when the sensor unit receives ambient light.

Therefore, the object detection processing can be performed on the basis of a light reception image including light having a wavelength different from that of the active light, and object detection accuracy can be improved.

Furthermore, in the first distance measuring device as the embodiment, the sensor unit (sensor unit 11A, 11B) is configured to be able to perform partial reading to read a light reception signal for only some pixels.

In the distance measurement of the present technology, it is sufficient to obtain a light reception signal at a position according to the object detection position. Therefore, as long as the sensor unit is configured to be able to perform partial reading, it is possible to selectively read only a light reception signal of a pixel at a position according to the object detection position to perform distance measurement.

Therefore, in measuring a distance to the target object, it is possible to reduce power consumption of the sensor unit and reduce a load of the distance measurement calculation processing.

Furthermore, in the first distance measuring device as the embodiment, the control unit (control unit 13A) instructs the sensor unit (sensor unit 11A) to perform partial reading on an object detection pixel region specified from an object detection processing result obtained by the object detection unit, and causes the calculation unit to calculate a distance on the basis of a light reception signal subjected to partial reading in response to the instruction.

By performing the distance calculation on the basis of a light reception signal obtained by performing partial reading on the object detection pixel region as described above, an amount of data handled in the distance calculation can be reduced.

Therefore, it is possible to reduce a load of the distance calculation processing.

Moreover, in the first distance measuring device as the embodiment, the sensor unit (sensor unit 11B) is configured to be able to perform event-based type partial reading, and the control unit (control unit 13B) controls the calculation unit to calculate the distance on the basis of a light reception signal subjected to partial reading by the sensor unit.

According to the configuration described above, it is possible to perform partial distance measurement without performing processing of instructing the sensor unit to use the object detection pixel region as the partial reading region.

Therefore, it is possible to reduce a processing load on the control processor included in the distance measuring device.

Furthermore, in the first distance measuring device as the embodiment, the control unit (control unit 13C) performs evaluation processing of evaluating whether or not reflected light from the target object is received in an object detection pixel region in the sensor unit for every irradiation position while changing the irradiation position of light emitted by the light emitting unit in a partial region including an object detection region in the distance measurable range, and the control unit (control unit 13C) performs control to output, as a value of a distance to the target object, a value based on a distance in the object detection pixel region and calculated by the calculation unit in a setting state of an irradiation position at a time when evaluation is made that reflected light from the target object is received in the object detection pixel region, in a case where the evaluation is made in the evaluation processing.

By evaluating whether or not the reflected light from the target object is received in the object detection pixel region while changing the irradiation position of the active light emitted by the light emitting unit as described above, it is possible to appropriately calculate the distance to the target object even when there is a baseline distance between the light emitting unit and the sensor unit.

Therefore, the distance measurement can be appropriately performed corresponding to a case where the light emitting unit and the sensor unit are disposed apart from each other.

Furthermore, in the first distance measuring device as the embodiment, the sensor unit (sensor unit 11A) is configured to be able to perform partial reading of reading a light reception signal for only some pixels, and the control unit (control unit 13C) causes the sensor unit to perform partial reading of a light reception signal of the object detection pixel region for every irradiation position, and performs evaluation on the basis of a light reception signal obtained by the partial reading, in the evaluation processing.

As a result, the light receiving operation by the partial reading can be performed for the light receiving operation for distance measurement repeatedly performed in the evaluation processing.

Therefore, it is possible to reduce power consumption of the sensor unit in executing the evaluation processing.

Moreover, in the first distance measuring device as the embodiment, the sensor unit (11B) is configured to be able to perform event-based type partial reading, and the control unit performs evaluation as to whether or not reflected light from the target object is received in the object detection pixel region on the basis of whether or not the light reception signal is read in the sensor unit, as the evaluation for every the irradiation position.

Since the sensor unit is configured to be able to perform event-based type partial reading, it is possible to prevent the light reception signal reading by the sensor unit from being performed unless the target object is irradiated with the active light at the time of the evaluation processing.

Therefore, according to the configuration described above, it is possible to reduce power consumption of the sensor unit at the time of the evaluation processing. Moreover, in order to improve distance measurement accuracy with respect to the baseline distance, it is not necessary to issue a partial reading instruction to the sensor unit at the time of the evaluation processing. Therefore, it is possible to reduce a processing load on a control processor included in the distance measuring device.

Furthermore, the first distance measuring device as the embodiment includes: an optical transmission control unit (filter effect control unit 17) configured to be switchable between a filter enabling mode in which an optical bandpass filter effect is applied to light received by the sensor unit and a filter disabling mode in which the optical bandpass filter effect is not applied to light received by the sensor unit, in which the optical bandpass filter effect sets a wavelength band of light emitted by the light emitting unit as a target wavelength band. The control unit controls the optical transmission control unit to the filter enabling mode in a case where the sensor unit performs light reception for distance measurement, and controls the optical transmission control unit to the filter disabling mode in a case where the sensor unit performs light reception for the object detection processing.

According to the configuration described above, since the filter enabling mode is set at the time of distance measurement, noise caused by ambient light can be reduced, and distance measurement accuracy can be improved. Whereas, at the time of the object detection processing, since the filter disabling mode is set, a light reception amount of ambient light can be increased, and object detection accuracy can be improved.

Therefore, it is possible to improve distance measurement accuracy (accuracy of the distance measurement performed on the basis of the object detection result) in both the noise reduction and the improvement of object detection accuracy in the distance measurement.

Furthermore, the first distance measuring device as the embodiment includes a beam steering unit (beam steering unit 16) that performs beam steering on light emitted by the light emitting unit.

By providing the beam steering unit, it is possible to improve a degree of freedom regarding a change of an irradiation position of the active light.

Moreover, in the first distance measuring device as the embodiment, the light emitting unit (light emitting unit 10D) includes a plurality of light sources (light emitting elements 10a) that individually emits light to different areas of the distance measurable range, and the control unit (control unit 13E) changes the light irradiation position by the light emitting unit depending on which light source is caused to emit light among the plurality of light sources.

As a result, for changing the irradiation position of the active light, it is not necessary to provide a mechanism, a drive unit, an optical component, and the like for beam steering in the optical system.

Therefore, it is possible to reduce a size and a weight of the optical system.

Furthermore, in the first distance measuring device as the embodiment, the object detection unit (object detection unit 15E) performs object detection processing on the basis of a gradation image obtained by the sensor unit and a sensing image obtained by the different sensor unit (different sensor unit 20) that obtains a sensing image whose type is different from a type of a sensing image obtained by the sensor unit.

According to the configuration described above, it is possible to perform the object detection processing by sensor fusion processing using not only the gradation image obtained by the sensor unit but also the sensing image obtained by the different sensor unit.

Therefore, accuracy of the object detection processing can be improved as compared with a case where the object detection processing is performed on the basis of only a sensing image obtained by a single sensor unit, and accuracy of the distance measurement performed on the basis of an object detection result can be improved.

Furthermore, a second distance measuring device (distance measuring device 1, 1A, 1B, 1C, 1E) as the embodiment includes: a sensor unit configured to perform a light receiving operation for distance measurement by a ToF method, for reflected light obtained when an object reflects light emitted from a light emitting unit that emits light; a calculation unit configured to calculate a distance by the ToF method on the basis of a light reception signal of the sensor unit; an object detection unit configured to perform object detection processing on the basis of a sensing image obtained by sensing on a distance measurable range that is a view angle range in which distance measurement can be performed using the sensor unit; and a control unit configured to control the calculation unit to calculate a distance to the target object on the basis of a light reception signal obtained by the sensor unit when a position according to a position of the target object detected by the object detection unit is irradiated with light emitted by the light emitting unit.

Also with such a second distance measuring device, it is possible to obtain functions and effects similar to those of the first distance measuring device described above.

Note that effects described in the present description are merely examples and are not limited, and other effects may be provided.

### 6. Present Technology

Note that the present technology can also have the following configurations.

(1)

A distance measuring device including:
a light emitting unit configured to emit light;
a sensor unit configured to perform a light receiving operation for distance measurement by a ToF method, for reflected light obtained when an object reflects light emitted from the light emitting unit;
a calculation unit configured to calculate a distance by the ToF method on the basis of a light reception signal of the sensor unit;
an object detection unit configured to perform object detection processing on the basis of a sensing image obtained by sensing on a distance measurable range that is a view angle range in which distance measurement can be performed using the sensor unit; and
a control unit configured to control the calculation unit to calculate a distance to a target object on the basis of a light reception signal obtained by the sensor unit when a position according to a position of the target object detected by the object detection unit is irradiated with light emitted by the light emitting unit.
   (2)

The distance measuring device according to (1) above, in which
the object detection unit performs the object detection processing on the basis of a gradation image generated on the basis of a light reception signal of the sensor unit.
   (3)

The distance measuring device according to (2) above, in which
the control unit
causes the object detection unit to execute the object detection processing on the gradation image obtained by causing the sensor unit to execute a light receiving operation in a state where the light emitting unit does not emit light.
   (4)

The distance measuring device according to any one of (1) to (3) above, in which
the sensor unit is configured to be able to perform partial reading of reading a light reception signal for only some pixels.
   (5)

The distance measuring device according to (4) above, in which
the control unit
gives an instruction to the sensor unit to perform partial reading of an object detection pixel region specified from an object detection processing result obtained by the object detection unit, and causes the calculation unit to calculate the distance on the basis of a light reception signal subjected to partial reading by the instruction.
   (6)

The distance measuring device according to (4) above, in which
the sensor unit is configured to be able to perform event-based type partial reading, and
the control unit
controls the calculation unit to calculate the distance on the basis of a light reception signal subjected to partial reading by the sensor unit.
   (7)

The distance measuring device according to any one of (1) to (6) above, in which
the control unit
performs evaluation processing of evaluating whether or not reflected light from the target object is received in an object detection pixel region in the sensor unit for every irradiation position of light while changing the irradiation position, the light being emitted by the light emitting unit in a partial region including an object detection region in the distance measurable range, and
performs control to output, as a value of a distance to the target object, a value based on a distance in the object detection pixel region and calculated by the calculation unit in a setting state of an irradiation position at a time when evaluation is made that reflected light from the target object is received in the object detection pixel region, in a case where the evaluation is made in the evaluation processing.
   (8)

The distance measuring device according to (7) above, in which
the sensor unit is configured to be able to perform partial reading of reading a light reception signal for only some pixels, and
the control unit
causes the sensor unit to perform partial reading of a light reception signal of the object detection pixel region for the every irradiation position, and performs the evaluation on the basis of a light reception signal obtained by the partial reading, in the evaluation processing.
   (9)

The distance measuring device according to (7) above, in which
the sensor unit is configured to be able to perform event-based type partial reading, and
the control unit
performs evaluation as to whether or not reflected light from the target object is received in the object detection pixel region on the basis of whether or not a light reception signal is read in the sensor unit, as the evaluation for the every irradiation position.
   (10)

The distance measuring device according to (2) or (3)

above, further including:
an optical transmission control unit configured to be switchable between a filter enabling mode in which an optical bandpass filter effect is applied to light received by the sensor unit and a filter disabling mode in which the optical bandpass filter effect is not applied to light received by the sensor unit, the optical bandpass filter effect setting a wavelength band of light emitted by the light emitting unit as a target wavelength band, in which
the control unit
controls the optical transmission control unit to the filter enabling mode in a case where the sensor unit performs light reception for distance measurement, and controls the optical transmission control unit to the filter disabling mode in a case where the sensor unit performs light reception for the object detection processing.
   (11)

The distance measuring device according to any one of (1) to (10) above, further including:
a beam steering unit configured to perform beam steering on light emitted by the light emitting unit.
   (12)

The distance measuring device according to any one of (1) to (10) above, in which
the light emitting unit includes a plurality of light sources configured to emit light to individually different areas of the distance measurable range, and
the control unit
changes an irradiation position of light emitted by the light emitting unit in accordance with a light source to be caused to emit light among the plurality of light sources.
   (13)

The distance measuring device according to (2) or (3) or (10) above, in which
the object detection unit
performs the object detection processing on the basis of the gradation image obtained by the sensor unit and a sensing image obtained by a different sensor unit that obtains a sensing image whose type is different from a type of a sensing image obtained by the sensor unit.
   (14)

A distance measuring device including:
a sensor unit configured to perform a light receiving operation for distance measurement by a ToF method, for reflected light obtained when an object reflects light emitted from a light emitting unit that emits light;
a calculation unit configured to calculate a distance by the ToF method on the basis of a light reception signal of the sensor unit;
an object detection unit configured to perform object detection processing on the basis of a sensing image obtained by sensing on a distance measurable range that is a view angle range in which distance measurement can be performed using the sensor unit; and
a control unit configured to control the calculation unit to calculate a distance to a target object on the basis of a light reception signal obtained by the sensor unit when a position according to a position of the target object detected by the object detection unit is irradiated with light emitted by the light emitting unit.

### REFERENCE SIGNS LIST

1, 1A, 1B, 1C, 1E Distance measuring device
10, 10D Light emitting unit
10a, 10a-1, 10a-2, 10a-3, 10a-4, 10a-5, 10a-6 Light emitting element
11, 11A, 11B Sensor unit
12, 12B Distance calculation unit
13, 13A, 13B, 13C, 13E Control unit
14, 14B Gradation image generation unit
15, 15E Object detection unit
16 Beam steering unit
17 Filter effect control unit
Ob Target object
Li Irradiation light
Lr Reflected light
Px Pixel
111, 111B Pixel array unit
120 Row drive line
120′ Pixel drive line
121, 121-A, 121-B Gate drive line
122, 122-A, 122-B Vertical signal line
PD Photodiode
FD, FD-A, FD-B Floating diffusion
TG, TG-A, TG-B Transfer transistor
Aa Distance measurable range
Ag Object detection pixel region
50 Electronic device
131 Row selection register
132 Column selection register
140 Detection unit
141 Arbiter unit
Sa, Sb Charge signal
Db Baseline distance
Po Object detection pixel position
Pi Irradiation position
Ar-1, Ar-2, Ar-1, Ar-2, Ar-1, Ar-2 Irradiation area
20 Different sensor unit

1. A distance measuring device comprising:
a light emitting unit configured to emit light;
a sensor unit configured to perform a light receiving operation for distance measurement by a ToF method, for reflected light obtained when an object reflects light emitted from the light emitting unit;
a calculation unit configured to calculate a distance by the ToF method on a basis of a light reception signal of the sensor unit;
an object detection unit configured to perform object detection processing on a basis of a sensing image obtained by sensing on a distance measurable range that is a view angle range in which distance measurement can be performed using the sensor unit; and
a control unit configured to control the calculation unit to calculate a distance to a target object on a basis of a light reception signal obtained by the sensor unit when a position according to a position of the target object detected by the object detection unit is irradiated with light emitted by the light emitting unit.

2. The distance measuring device according to claim 1, wherein
the object detection unit performs the object detection processing on a basis of a gradation image generated on a basis of a light reception signal of the sensor unit.

3. The distance measuring device according to claim 2, wherein
the control unit
causes the object detection unit to execute the object detection processing on the gradation image obtained by causing the sensor unit to execute a light receiving operation in a state where the light emitting unit does not emit light.

4. The distance measuring device according to claim 1, wherein
the sensor unit is configured to be able to perform partial reading of reading a light reception signal for only some pixels.

5. The distance measuring device according to claim 4, wherein
the control unit
gives an instruction to the sensor unit to perform partial reading of an object detection pixel region specified from an object detection processing result obtained by the object detection unit, and causes the calculation unit to calculate the distance on a basis of a light reception signal subjected to partial reading by the instruction.

6. The distance measuring device according to claim 4, wherein
the sensor unit is configured to be able to perform event-based type partial reading, and
the control unit
controls the calculation unit to calculate the distance on a basis of a light reception signal subjected to partial reading by the sensor unit.

7. The distance measuring device according to claim 1, wherein
the control unit
performs evaluation processing of evaluating whether or not reflected light from the target object is received in an object detection pixel region in the sensor unit for every irradiation position of light while changing the irradiation position, the light being emitted by the light emitting unit in a partial region including an object detection region in the distance measurable range, and
performs control to output, as a value of a distance to the target object, a value based on a distance in the object detection pixel region and calculated by the calculation unit in a setting state of an irradiation position at a time when evaluation is made that reflected light from the target object is received in the object detection pixel region, in a case where the evaluation is made in the evaluation processing.

8. The distance measuring device according to claim 7, wherein
the sensor unit is configured to be able to perform partial reading of reading a light reception signal for only some pixels, and
the control unit
causes the sensor unit to perform partial reading of a light reception signal of the object detection pixel region for the every irradiation position, and performs the evaluation on a basis of a light reception signal obtained by the partial reading, in the evaluation processing.

9. The distance measuring device according to claim 7, wherein
the sensor unit is configured to be able to perform event-based type partial reading, and
the control unit
performs evaluation as to whether or not reflected light from the target object is received in the object detection pixel region on a basis of whether or not a light reception signal is read in the sensor unit, as the evaluation for the every irradiation position.

10. The distance measuring device according to claim 2, further comprising:
an optical transmission control unit configured to be switchable between a filter enabling mode in which an optical bandpass filter effect is applied to light received by the sensor unit and a filter disabling mode in which the optical bandpass filter effect is not applied to light received by the sensor unit, the optical bandpass filter effect setting a wavelength band of light emitted by the light emitting unit as a target wavelength band, wherein
the control unit
controls the optical transmission control unit to the filter enabling mode in a case where the sensor unit performs light reception for distance measurement, and controls the optical transmission control unit to the filter disabling mode in a case where the sensor unit performs light reception for the object detection processing.

11. The distance measuring device according to claim 1, further comprising:
a beam steering unit configured to perform beam steering on light emitted by the light emitting unit.

12. The distance measuring device according to claim 1, wherein
the light emitting unit includes a plurality of light sources configured to emit light to individually different areas of the distance measurable range, and
the control unit
changes an irradiation position of light emitted by the light emitting unit in accordance with a light source to be caused to emit light among the plurality of light sources.

13. The distance measuring device according to claim 2, wherein
the object detection unit
performs the object detection processing on a basis of the gradation image obtained by the sensor unit and a sensing image obtained by a different sensor unit that obtains a sensing image whose type is different from a type of a sensing image obtained by the sensor unit.

14. A distance measuring device comprising:
a sensor unit configured to perform a light receiving operation for distance measurement by a ToF method, for reflected light obtained when an object reflects light emitted from a light emitting unit that emits light;
a calculation unit configured to calculate a distance by the ToF method on a basis of a light reception signal of the sensor unit;
an object detection unit configured to perform object detection processing on a basis of a sensing image obtained by sensing on a distance measurable range that is a view angle range in which distance measurement can be performed using the sensor unit; and
a control unit configured to control the calculation unit to calculate a distance to a target object on a basis of a light reception signal obtained by the sensor unit when a position according to a position of the target object detected by the object detection unit is irradiated with light emitted by the light emitting unit.
